(19) United States
(12) Patent Application Publication
(10) Pub. No.: US 2016/0105502 A1
(43) Pub. Date: Apr. 14, 2016

(54) DATA SYNCHRONIZATION METHOD, DATA SYNCHRONIZATION APPARATUS, AND DISTRIBUTED SYSTEM

(71) Applicant: Huawei Technologies Co., Ltd., Shenzhen (CN)

(72) Inventor: Ke Shen, Hangzhou (CN)

(21) Appl. No.: 14/974,368

(22) Filed: Dec. 18, 2015

Related U.S. Application Data
(63) Continuation of application No. PCT/CN2014/079921, filed on Jun. 16, 2014.

(30) Foreign Application Priority Data
Jun. 20, 2013 (CN) 201310246590.1

(51) Int. Cl. H04L 29/08; H04L 12/751; H04L 12/721

(52) U.S. Cl. CPC H04L 67/1065; H04L 67/1063; H04L 45/44; H04L 45/02

(57) ABSTRACT

A data synchronization method, a data synchronization apparatus, and a distributed system are disclosed. A management node acquires a route update message that instructs to update routing information of the first data center and the second data center, where the routing information includes at least identification information of the first data center and the second data center, and backup routing information of nodes in the first data center and the second data center; the management node adjusts the routing information of the first data center and the second data center according to the route update message; and the management node synchronizes adjusted routing information of the first data center and the second data center to the first data center and the second data center, so that the first data center and the second data center perform, based on the adjusted routing information, synchronous transmission on data of managed nodes.

### CROSS-REFERENCE TO RELATED APPLICATIONS

This application is a continuation of International Application No. PCT/CN2014/079921, filed on Jun. 16, 2014, which claims priority to Chinese Patent Application No. 201310246590.1, filed on Jun. 20, 2013, both of which are hereby incorporated by reference in their entireties.

### TECHNICAL FIELD

The present invention relates to the field of data storage, and specifically, to a data synchronization method, a data synchronization apparatus, and a distributed system.

### BACKGROUND

With the development of big data technologies, in order to effectively solve problems of an access delay and a risk that are caused by data concentration, generally, multiple data centers that include a service data center and a backup data center are constructed based on a distributed system. In addition, operating statuses of a server in a data center and of each data center in the multiple data centers are confirmed in time. A service data center is used as an example; when the service data center cannot run normally, subsequent access of a user is redirected, based on a principle of proximity, to another service data center that runs normally; and when a server of the service data center cannot run normally, similarly, subsequent access of a user is redirected to another server in this service data center based on the principle of proximity. However, in the case of multiple data centers, in order to meet a requirement of redundancy and close-by access, the backup data center synchronizes data from the service data center according to a consistency requirement, which inevitably causes that information of the service data center and the backup data center is exchanged; once there are a large amount of exchanged information in the multiple data centers, which inevitably results in that sealability between data centers becomes poor, so that independence of each data center is reduced. If the sealability between data centers is ensured in a manner of forwarding, because a forward node needs to forward all synchronous data of the multiple data centers, and forwarding efficiency of the forward node has a bottleneck, a bottleneck effect is inevitably caused, so that transmission of the synchronous data of the multiple data centers may also encounter a bottleneck effect.

In the distributed system, a consistent hash (hash) ring is generally used to implement fragmented storage and fragmented query of data, and fragmentation is implemented according to several ranges (consecutive value ranges) included in the consistent hash ring. A data center is used as an example; specifically, as shown in FIG. 1, the data center includes four nodes that are a node 11, a node 12, a node 13, and a node 14, each node includes one or more servers, and a value range of a consistent hash ring 10 is 0 to 2̂128, where the node 11 maps to a position A on the consistent hash ring 10, the node 12 maps to a position B on the consistent hash ring 10, the node 13 maps to a position C on the consistent hash ring 10, and the node 14 maps to a position D on the consistent hash ring 10, so that a range mapped by the node 11 is [D, A), a range mapped by the node 12 is [A, B), a range mapped by the node 13 is [B, C), and a range mapped by the node 14 is [C, D). Data of each node in the four nodes is backed up in at least one of the other nodes. For example, data in the node 11 is backed up in the node 12, or the data in the node 11 is backed up in each node of the node 12, the node 13, and the node 14. Therefore, when a node cannot run normally, a case of data loss is prevented.

In the prior art, it is proposed that data synchronization in the multiple data centers is implemented by using a transit node and data synchronization in the multiple data centers is implemented based on a same distributed hash table (Distributed Hash Table, DHT) ring. In databases Data Guard and mysql of Oracle, data synchronization in the multiple data centers is implemented by constructing a transit node group between data centers, so that all data transmission in the multiple data centers need to be performed by using the transit node group. However, when a quantity of user terminals becomes increasingly large, the amount of data needed to be transited by the transit node group also becomes increasingly large, which inevitably causes that the transit node group encounters a bottleneck effect.

Secondly, when data synchronization in the multiple data centers is implemented based on a same DHT ring, all nodes in the multiple data centers map to one DHT ring, so that the multiple data centers can share, by using the nodes, a large quantity of synchronization requests between data centers in a case of a large quantity of operation requests of users. Specifically, the database Cassandra is used as an example; referring to FIG. 2, a data center 21 and a data center 22 map to a DHT ring 20; in the data center 21, a range mapped by a node 23 is [D, A), a range mapped by a node 25 is [E, B), a range mapped by a node 27 is [F, C), and a range mapped by a node 29 is [G, D); and in the data center 22, a range mapped by a node 24 is [A, E), a range mapped by a node 26 is [B, F), and a range mapped by a node 28 is [C, G). When a hash value of an operation request of a user falls within the range interval [D, A), the node 23 responds to the operation request. When data in the node 23 changes, changed data needs to be backed up to the node 24. Because the node 23 belongs to the data center 21 and the node 24 belongs to the data center 22, interaction is performed between the data center 21 and the data center 22. When the hash value of the operation request falls within the range interval [B, F), the node 26 responds to the operation request. When data in the node 26 changes, changed data needs to be backed up into the node 27. Because the node 26 belongs to the data center 22 and the node 27 belongs to the data center 21, data interaction is performed between the data center 21 and the data center 22. When there is a large quantity of operation requests, data interaction between the data center 21 and the data center 22 increases, and therefore, seal ability between the data center 21 and the data center 22 becomes poor.

In conclusion, in a method for implementing data synchronization of multiple data centers proposed in the prior art, there is either a bottleneck effect during synchronous transmission of data or a technical problem of poor seal ability.

### SUMMARY

Embodiments of the present application provides a data synchronization method, a data synchronization apparatus, and a distributed system, which can avoid a bottleneck effect existing during synchronous transmission of data, improve efficiency of the synchronous transmission of data, and enhance seal ability of data centers.

According to a first aspect of the present invention, a data synchronization method is provided, multiple data centers include at least two data centers, each data center in the at least two data centers includes at least two nodes, all service nodes in the at least two data centers map to one distributed hash table DHT ring, each consecutive value range in the DHT ring is corresponding to a service node, a service node in a first data center in the at least two data centers has at least one backup node that is in at least one second data center in the at least two data centers and whose data interval distribution is corresponding to that of the service node, and the method includes: acquiring, by a management node, a route update message that instructs to update routing information of the first data center and the second data center, where the routing information includes at least identification information of the first data center and the second data center, and backup routing information of nodes in the first data center and the second data center; adjusting, by the management node, the routing information of the first data center and the second data center according to the route update message; and synchronizing, by the management node, adjusted routing information of the first data center and the second data center to the first data center and the second data center, so that the first data center and the second data center perform, based on the adjusted routing information, synchronous transmission on data of managed nodes.

In the embodiments of the present invention, a management node adjusts routing information of a first data center and a second data center only when a route update message that instructs to update the routing information of the first data center and the second data center is acquired, and then data synchronization between the first data center and the second data center is performed based on the adjusted routing information of the first data center and the second data center. In this way, data synchronization between the first data center and the second data center can be implemented only when the foregoing restrictive condition is met, thereby ensuring sealability between data centers in multiple data centers. Besides, data is transmitted not by using a transit node, but is directly transmitted between correlated nodes, thereby avoiding a bottleneck effect of the multiple data centers during synchronous transmission of data, so that efficiency of the synchronous transmission of data becomes higher.

### BRIEF DESCRIPTION OF THE DRAWINGS

FIG. 1 is a structural diagram of a consistent hash ring mapped by a data center in a distributed system in the prior art;

FIG. 2 is a structural diagram of a DHT ring mapped by a data center 21 and a data center 22 in the prior art;

FIG. 3a is a structure diagram of a DHT ring mapped by a data center 1 according to an embodiment of the present invention;

FIG. 3b is a structure diagram of a DHT ring mapped by a data center 2 according to an embodiment of the present invention;

FIG. 3c is a structure diagram of a DHT ring mapped by a data center 3 according to an embodiment of the present invention;

FIG. 4 is a first flowchart of a data synchronization method according to an embodiment of the present invention;

FIG. 5a is a structure diagram of a DHT ring mapped by a service data center 4 according to an embodiment of the present invention;

FIG. 5b is a structure diagram of a DHT ring mapped by a backup data center 5 according to an embodiment of the present invention;

FIG. 6 is a second flowchart of a data synchronization method according to an embodiment of the present invention;

FIG. 7 is a first structure diagram of a data synchronization apparatus according to an embodiment of the present invention;

FIG. 8 is a structure diagram of a first route adjustment unit according to an embodiment of the present invention;

FIG. 9 is a second structure diagram of a data synchronization apparatus according to an embodiment of the present invention; and

FIG. 10 is an overall architecture diagram of a distributed system according to an embodiment of the present invention.

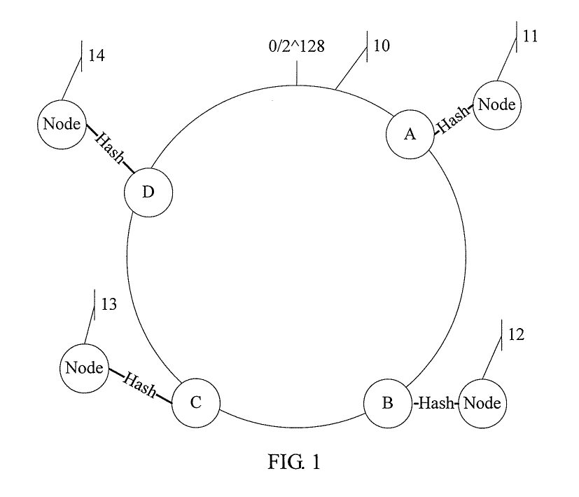

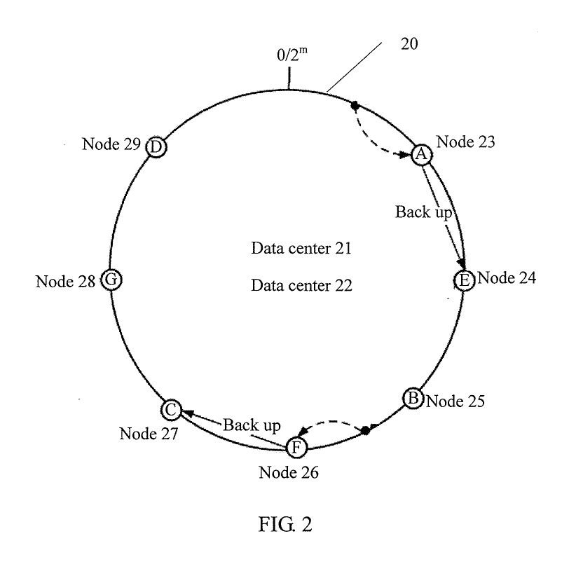

### DETAILED DESCRIPTION

The present invention targets either a bottleneck effect during synchronous transmission of data or a technical problem of poor seal ability that exists in the prior art when data synchronization in multiple data centers is implemented.

The term “and/or” in this specification describes only an association relationship for describing associated objects and represents that three relationships may exist. For example, A and/or B may represent the following three cases: Only A exists, both A and B exist, and only B exists. In addition, the character “1” in this specification generally indicates an “or” relationship between the associated objects.

In addition, the terms of “service node” and “backup node” in this specification are specifically as follows: The service node may include one or more servers, the service node can respond to an operation request of a user, and according to the operation request, the service node can read, add, delete, and modify data stored in the service node; likewise, the backup node may also include one or more servers, but the backup node cannot respond to the operation request of the user, instead, the backup node is used to back up data in a corresponding service node, and any one service node and a backup node corresponding to the any one service node are separately distributed in different data centers, so as to prevent a problem, caused by a breakdown of a data center, that data is lost and cannot be recovered.

The following expounds primary implementation principles, specific implementation manners, and corresponding beneficial effects that can be achieved, of the technical solutions in the embodiments of the present invention with reference to accompanying drawings.

### Embodiment 1

Embodiment 1 of the present invention proposes a data synchronization method. Multiple data centers include at least two data centers, where each data center in the at least two data centers includes at least two nodes, all service nodes in the at least two data centers map to one distributed hash table DHT ring, each consecutive value range in the DHT ring is corresponding to a service node, and a service node in a first data center in the at least two data centers has at least one backup node that is in at least one second data center in the at least two data centers and whose data interval distribution is corresponding to that of the service node.

In a specific implementation process, that a service node in a first data center in the at least two data centers has at least one backup node that is in at least one second data center in the at least two data centers and whose data interval distribution is corresponding to that of the service node includes two cases. In case 1, for all service nodes in the first data center, corresponding backup node s can be found in the at least one second data center. In addition, in case 2, only for first partial service nodes in all service nodes in the first data center, corresponding backup nodes can be found in the at least one second data center, and second partial service nodes, except the first partial service nodes, in all the service nodes in the first data center have no corresponding backup node. Moreover, nodes in the first data center may include not only a service node but also a backup node.

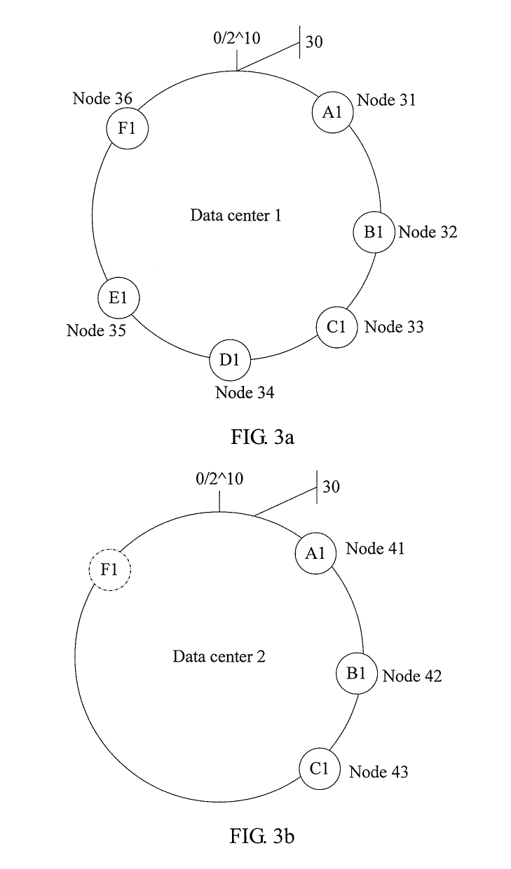

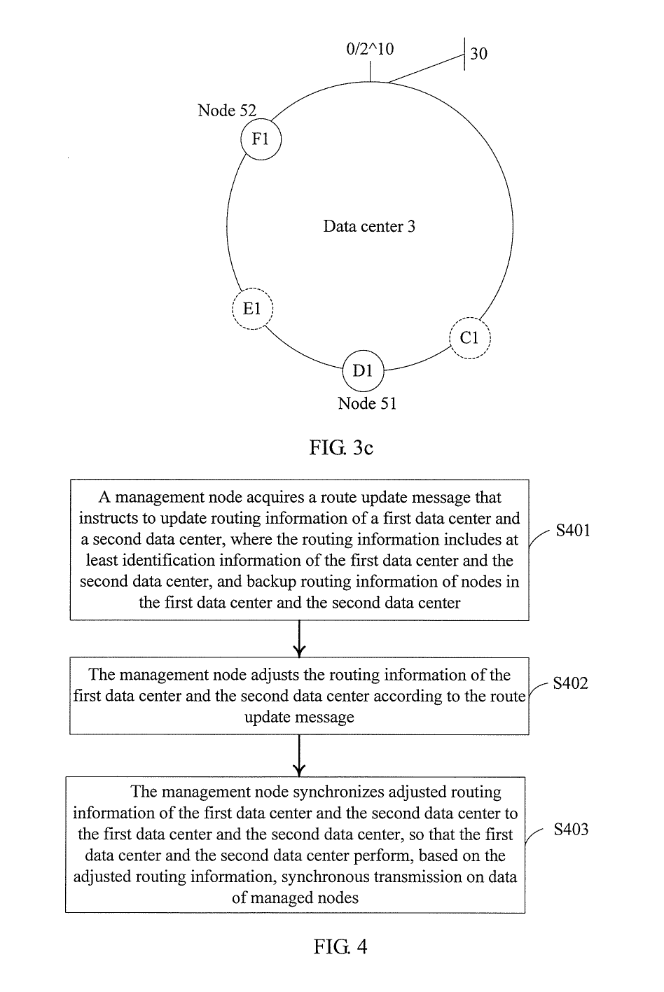

For example, referring to FIG. 3a, FIG. 3b, and FIG. 3c, the multiple data centers include a data center 1, a data center 2 and a data center 3, where the data center 1 is the first data center, and the data center 2 and the data center 3 are the at least one second data center. The data center 1 includes six service nodes that are a node 31, a node 32, a node 33, a node 34, a node 35, and a node 36, and the six service nodes map to a DHT ring 30, where the node 31 maps to a position A1 on the DHT ring 30 and a range mapped by the node 31 is [F1, A1), the node 32 maps to a position B1 on the DHT ring 30 and a range mapped by the node 32 is [A1, B1), the node 33 maps to a position C1 on the DHT ring 30 and a range mapped by the node 33 is [B1, C1), the node 34 maps to a position D1 on the DHT ring 30 and a range mapped by the node 34 is [C1, D1), the node 35 maps to a position E1 on the DHT ring 30 and a range mapped by the node 35 is [D1, E1), and the node 36 maps to a position F1 on the DHT ring 30 and a range mapped by the node 36 is [E1, F1). Because a node and a position mapped by the node on a DHT ring in this specification can be more visually obtained from the accompanying drawings, for the conciseness of the specification, details are not described again in the following.

The data center 2 includes three backup nodes that are a node 41, a node 42, and a node 43, and the three backup nodes map to the DHT ring 30. A range mapped by the node 41 is [F1, A1), a range mapped by the node 42 is [A1, B1), and a range mapped by the node 43 is [B1, C1), which results in that two nodes in the node 41 and the node 31, the node 42 and the node 32, and the node 43 and the node 33 are separately corresponding to a same range, that is, the node 41 is corresponding to the node 31, the node 42 is corresponding to the node 32, and the node 43 is corresponding to the node 33. Therefore, it may be determined that each service node is corresponding to only one backup node and each backup node is corresponding to one service node, so that range distribution of the data center 2 is divided according to range distribution of the data center 1, and there is a data center 2 whose data interval distribution is corresponding to that of the data center 1.

The data center 3 includes two backup nodes that are a node 51 and a node 52, and the two backup nodes map to the DHT ring 30, where a range mapped by the node 51 is [C1, D1), and a range mapped by the node 52 is [E1, F1), which results in that the node 51 and the node 34 are corresponding to each other and are corresponding to a same range, and the node 52 and the node 36 are also corresponding to each other and separately map to a same range. In addition, the node 52 may further map to [E1, F1) and [D1, E1), and the node 51 may map to three ranges that are [C1, D1), [B1, C1), and [A1, B1), which results in that the node 52 is separately corresponding to the node 35 and the node 36, and the node 51 is corresponding to the node 31, the node 32, and the node 33. Therefore, one backup node may be corresponding to multiple service nodes, and range distribution of the data center 3 is also divided according to the range distribution of the data center 1, so that there is a data center 3 whose data interval distribution is corresponding to that of the data center 1.

Furthermore, the data center 3 may also include a node 53 that maps to the position C1 on the DHT ring 30 and a node 54 that maps to the position B1 on the DHT ring 30, where a range mapped by the node 53 is [B1, C1) and a range mapped by the node 54 is [A1, B1), so that the node 53 is corresponding to the node 33, and the node 54 is corresponding to the node 32. Because the node 42 in the data center 2 is corresponding to the node 32, and the node 43 is corresponding to the node 33, it indicates that the node 32 is corresponding to the node 42 and the node 54, and the node 33 is corresponding to the node 43 and the node 53. Certainly, another first data center may further be set, and backup nodes respectively corresponding to the node 31, the node 32, the node 33, the node 34, the node 35, and the node 36 are set in the another first data center, so that one service node may also be corresponding to multiple backup nodes.

In a specific implementation process, each data center in the multiple data centers is a service data center or a backup data center, and a structure of the first data center and the second data center may be a service data center-backup data center structure. If a structure of a group of data centers in the multiple data centers is the service data center-backup data center structure, each service data center in the group of data centers includes only service nodes, and each backup data center in the group of data centers includes only backup nodes. Specifically, as shown in FIG. 3a, FIG. 3b, and FIG. 3c, a structure of the data center 1 and the corresponding data center 2 and data center 3 is the service data center-backup data center structure. Because all nodes in the data center 1 are service nodes, the data center 1 is the service data center, and because all nodes in the data center 2 and data center 3 are backup nodes, both the data center 2 and data center 3 are all backup data centers.

As shown in FIG. 4, a specific processing process of the method is as follows:

S401: A management node acquires a route update message that instructs to update routing information of the first data center and the second data center, where the routing information includes at least identification information of the first data center and the second data center, and backup routing information of nodes in the first data center and the second data center.

S402: The management node adjusts the routing information of the first data center and the second data center according to the route update message.

S403: The management node synchronizes adjusted routing information of the first data center and the second data center to the first data center and the second data center, so that the first data center and the second data center perform, based on the adjusted routing information, synchronous transmission on data of managed nodes.

In step S401, the management node acquires the route update message that instructs to update the routing information of the first data center and the second data center, where the routing information includes at least the identification information of the first data center and the second data center, and the backup routing information of the nodes in the first data center and the second data center.

The second data center and the at least one second data center have the same meaning. For example, when the at least one second data center is a data center A and a data center B, the second data center represents the data center A and the data center B.

In a specific implementation process, the management node may include one or more servers, the management node is communicatively connected to each data center in the multiple data centers, and routing table information of each data center in the multiple data centers is stored in the management node, where the routing table information includes identification information uniquely corresponding to each data center and routing information of each data center. For example, referring to FIG. 3a, FIG. 3b, and FIG. 3c, identification information uniquely corresponding to the data center 1 is DC1, identification information uniquely corresponding to the data center 2 is DC2, and identification information uniquely corresponding to the data center 3 is DC3.

Specifically, when there are a relatively large quantity of backup nodes and service nodes in the multiple data centers, the management node cannot monitor all backup nodes and service nodes in real time, which results in that the routing table information stored in the management node cannot be updated in time. In this case, self-monitoring may be performed by each data center in the multiple data centers. For example, the data center 1 monitors data change of the data center 1 in real time, and when it is monitored that the data change includes information such as change in range distribution, the data center 1 sends, to the management node, request information that instructs to update routing information of the data center 1.

Specifically, in order to better manage routing information of each data center in the multiple data centers, the routing information of each data center may further include routing number information. For example, routing number information of the data center 1 shown in Table 1 is represented, for example, by a number 10 or a character “a”. When the identification information of the data center 1 is changed from DC1 to DC4, the routing number information of the data center 1 is adjusted from the number 10 to a number 11, or adjusted from the character “a” to a character “b”, so that the management node can determine, by using only the routing number information of the data center 1, whether routing information of each node in all the nodes included in the data center 1 is latest routing information. For example, assuming that routing number information of the data center 1 stored in the management node is 11, and routing number information of the data center 1 stored in the node 35 is 10, it can be quickly determined that the routing information in the node 35 needs to be synchronized. Therefore, the routing information, in the management node, corresponding to the routing number information 11 is synchronized to the node 35, so that the node 35 updates the stored routing information of the data center 1.

Specifically, routing information of any one data center in the multiple data centers further includes online node information, and/or failed node information, and/or temporary backup node information of the data center. Referring to FIG. 3b, if the data center 2 includes a node 41, a node 42, a node 43, a node 44, a node 45, and a node 46, online node of the data center 2 includes the node 41, the node 42, the node 43, the node 44, and the node 45, but only the node 41, the node 42, and the node 43 map to the DHT ring 30, where the online node information is recorded in a form of a list to facilitate query. A failed node of the data center 2 includes the node 46, and the failed node information is also recorded in a form of a list to facilitate query. The a temporary backup node that is used to back up data in the node 41 is the node 44 and/or the node 45 may be recorded in the temporary backup node information, so that the temporary backup node information includes the node 44 and/or the node 45, and a node corresponding to the temporary backup node information must be at least one node in the online nodes in the data center 2.

In addition, a data structure between nodes included in any one data center in the multiple data centers may be set to a master node-slave nodes (master-slaves) structure, any one node and a slave node corresponding to the any one node are nodes in a same data center, and the slave node is used to back up data in the any one node. Certainly, the nodes included in the any one data center may also be independent from each other, so that data in the nodes included in the any one data center are not backed up. An example in which the data structure between the nodes included in the any one data center is the master-slaves structure is used in the following.

Specifically, in a data center of the multiple data centers, there may be a node that is neither a backup node nor a service node, but is used only as a slave node of a backup node and/or a service node.

For example, referring to FIG. 3b, the node 41 maps to [F1, A1), which indicates that the node 41 is a master node mapped to [F1, A1), and the node 42 and/or the node 43 may be used as a slave node of the node 41. When the slave nodes of the node 41 are the node 42 and the node 43, data stored in the node 41 is separately backed up in the node 43 and the node 42. Likewise, the node 41 and/or the node 43 may be used as a slave node of the node 42, and the node 41 and/or the node 42 may be used as a slave node of the node 43, so that when any one node in the data center 2 encounters a case such as disconnecting, or a system breakdown, data of the any one node is saved in a slave node corresponding to the any one node, so as to prevent a problem that a data loss occurs in the data center 2.

In addition, the data center 2 may further include a node 44 that maps to the position F1 on the DHT ring 30, and the node 44 is used only as a slave node of the node 41, the node 42, and the node 43. Because the node 41, the node 42, and the node 43 are all backup nodes, the node 44 is used only as the slave node of the backup nodes. Likewise, a node 37 may be added to the data center 1, and the node 37 is used only as a slave node of the node 31 and the node 32. Because both the node 31 and the node 32 are service nodes, the node 37 is used only as the slave node of the service nodes. Likewise, when a data center of the multiple data centers includes both a service node and a backup node, a first node that is used only as a slave node of the service node and the backup node of the data center may further be set in the data center, so that the first node is used only as the slave node of the service node and the backup node.

The backup routing information includes range information corresponding to a node, attribute information indicating that the node is a service node or a backup node, and backup node information of the node, where when the node is a service node, the backup node information of the node is routing information of a backup node that is used to back up data in the node.

In a specific implementation process, when attribute information of any one node in the multiple data centers indicates that the node is a service node, backup node information of the any one node is routing information of a backup node that is used to back up data in the node.

Specifically, the backup routing information of any one service or backup node in the multiple data centers further includes a name and an IP address of the service or backup node, and certainly may further include a storage space capacity of the service or backup node and a quantity of servers included in the service or backup node.

TABLE 1

| | | | Related | | | Backup node information | |
|---|---|---|---|---|---|---|---|
| | | | information | Related | | Second | |
| First identification | Range | Attribute | of a master | information | | identification | Related information |
| information | distribution | information | node | of a slave node | | information | of a backup node |
| DC1 | [F1, A1) | TRUE | Node 31 | Node | Node 33 | DC2 | Node 41 |
| | | | | 32 | | | |
| | [A1, B1) | TRUE | Node 32 | Node | Node 33 | DC2 | Node 42 |
| | | | | 31 | | | |
| | [B1, C1) | TRUE | Node 33 | Node | Node 34 | DC2 | Node 43 |
| | | | | 32 | | | |
| | [C1, D1) | TRUE | Node 34 | Node | Node 35 | DC3 | Node 51 |
| | | | | 31 | | | |
| | [D1, E1) | TRUE | Node 35 | Node | Node 36 | # | # |
| | | | | 33 | | | |
| | [E1, F1) | TRUE | Node 36 | Node | Node 35 | DC3 | Node 52 |
| | | | | 32 | | | |

The related information of a master node in Table 1 is routing information of each node in the data center 1, the first identification information in Table 1 is uniquely corresponding identification information of the data center 1, the range distribution in Table 1 is range distribution mapped by each node in the data center 1, the related information of a slave node in Table 1 is routing information of a slave node of each node in the data center 1, and the backup node information in Table 1 is routing information of a backup node that is used to back up data in each node in the data center 1. For details about the following tables, refer to the foregoing explanation, and for conciseness of the specification, details are not described again in the following.

For example, referring to FIG. 3a, Table 1 is routing information corresponding to the data center 1, range distribution mapped by the data center 1 includes six ranges that are [F1, A1), [A1, B), [B1, C1), [C1, D1), [D1, E1), and [E1, F1). Because all nodes in the data center 1 are service nodes, and the nodes in the data center 1 includes the node 31, the node 32, the node 33, the node 34, the node 35, and the node 36, the related information of a master node in Table 1 is the node 31 and an IP address of the node 31, the node 32 and an IP address of the node 32, the node 33 and an IP address of the node 33, the node 34 and an IP address of the node 34, the node 35 and an IP address of the node 35, and the node 36 and an IP address of the node 36.

The node 31 is as an example. The backup routing information of the node 31 includes identification information DC1 that is of the data center 1 and is corresponding to the node 31, the range interval mapped by the node 31 is [F1, A1), and the attribute information TRUE of the node 31 indicating that the node 31 is a service node. The related information of a slave node that is used to back up data in the node 31 and is in the data center 1 includes an IP address of the node 32, for example, 159.226.1.1 or 128.0.0.15, and an IP address of the node 33, for example, 159.226.1.144 or 128.0.0.241. For information about a backup node that is used to back up, in the data center 2, data in the node 31, the backup node information of the node 31 includes second identification information DC2 of the data center 2 and an IP address, for example, 159.226.1.21 or 128.0.0.45, of the node 41 that is used to back up data in the node 31 and is in the data center 2. Certainly, the related information of a slave node of the node 31 may further include information such as a storage space capacity of the node 32, for example, 256G or 2048G, and a quantity of servers of the node 32, for example, 1 or 2.

In addition, the attribute information of the node 31 may further be represented by using information such as FALSE, 1, or a, which is not specifically limited in this embodiment of the application.

The range interval mapped by the node 35 is [D1, E1), and because in the multiple data centers, there is no backup node corresponding to the node 35, the backup node information corresponding to [D1, E1) is represented by a symbol #, or represented by a space or “/”, which is used to indicate that, in the multiple data centers, there is no backup node information corresponding to the node 35.

In a specific implementation process, when attribute information of any one node in the multiple data centers indicates that the node is a backup node, because any one backup node has only at least one service node corresponding to the any one backup node and has no backup node corresponding to the any one backup node, so that backup node information of the any one backup node is blank, which is specifically shown in the following Table 2.

TABLE 2

| | | | Related | | | Backup node information | |
|---|---|---|---|---|---|---|---|
| | | | information | | | Second | |
| First identification | Range | Attribute | of a master | Related information of | | identification | Related information |
| information | distribution | information | node | a slave node | | information | of a backup node |
| DC2 | [F1, A1) | FALSE | Node 41 | Node 42 | Node 43 | # | # |
| | [A1, B1) | FALSE | Node 42 | Node 41 | Node 43 | # | # |
| | [B1, C1) | FALSE | Node 43 | Node 41 | Node 42 | # | # |

For example, referring to FIG. 3b, Table 2 is routing information corresponding to the data center 2. The first identification information of the data center 2 is DC2, the range distribution mapped by the data center 2 includes three ranges that are [F1, A1), [A1, B1), and [B1, C1), and the attribute information of the node 41, the node 42, and the node 43 is FALSE, which indicates that the node 41, the node 42, and the node 43 are all backup nodes, so that the second identification information and the related information of a backup node in the backup node information are represented by #, that is, there is no backup node that is used to back up data in the node 41, the node 42, and the node 43. For details about the related information of a master node and the related information of a slave node of the node 41, the node 42, and the node 43, refer to Table 2, and details are not described herein again.

Because routing information corresponding to any one data center in the multiple data centers may be shown in Table 1 and Table 2, when the any one data center, for example, the data center 1, is a service data center, and when one piece of or any combination of pieces of information of the first identification information, the range distribution, the attribute information, the related information of a master node, the related information of a slave node, and the backup node information of the data center 1 changes, the routing information of the data center 1 may also change. The management node may actively monitor each data center in the multiple data centers, so that the management node can acquire the route update message. When no information of the data center 1 changes, the management node cannot acquire the route update message. The foregoing method is also applicable to the data center 2 and the data center 3. Certainly, the data center 1, the data center 2, and the data center 3 may also actively send the route update message.

Subsequently, step S402 is performed. In this step, the management node adjusts the routing information of the first data center and the second data center according to the route update message.

In a specific implementation process, the management node adjusts the backup routing information in the routing information of the first data center and the second data center according to a parameter in the route update message, where the parameter in the route update message includes one or any combination of a parameter of change of a range mapped by a service node that is corresponding to a backup node, a parameter of change of a backup node, and a parameter of a range service switchover corresponding to a backup node or service node, where the parameter of a range service switchover corresponding to the backup node or service node is a parameter that is used to indicate that the backup node or the service node serves as a service node or a backup node.

The parameter of a range service switchover corresponding to the backup node is a parameter that is used to indicate that the backup node is switched to a service node, and the parameter of a range service switchover corresponding to the service node is a parameter that is used to indicate that the service node is switched to a backup node.

Specifically, referring to FIG. 3a and Table 1, when a new node is added into the range interval [F1, A1), [A1, B1), [B1, C1), [C1, D1), or [E1, F1) in the data center 1, or the node 31, the node 32, the node 33, the node 34, or the node 36 is disconnected, because the node 31, the node 32, the node 33, the node 34, and the node 36 each have a corresponding backup node, the parameter in the route update message includes the parameter of change of a range mapped by a service node that is corresponding to a backup node.

Referring to FIG. 3b and FIG. 3c, when the node 41, the node 42, or the node 43 in the data center 2 is disconnected, or when the node 51 or the node 52 in the data center 3 is disconnected, it may be determined that the parameter in the route update message includes the parameter of change of a backup node; and when the attribute information of the node 31 in the data center 1 is switched from TRUE to FALSE, or the attribute information of the node 42 in the data center 2 is switched from FALSE to TRUE, it may be determined that the parameter in the route update message includes the parameter of a range service switchover corresponding to the backup node or service node.

In addition, when the node 31 in the data center 1 is disconnected, the node 42 in the data center 2 is disconnected, and the attribute information of the node 36 in the data center 1 needs to be switched from TRUE to FALSE, the parameter in the route update message includes the parameter of change of a range mapped by a service node that is corresponding to a backup node, the parameter of change of a backup node, and the parameter of a range service switchover corresponding to the backup node or service node.

When it is determined that the parameter in the route update message includes one or any combination of the parameter of change of a range mapped by a service node that is corresponding to a backup node, the parameter of change of a backup node, and the parameter of a range service switchover corresponding to the backup node or service node, the management node adjusts the backup routing information in the routing information of the first data center and the second data center according to the parameter in the route update message.

Specifically, when the parameter in the route update message is a parameter of change of a range mapped by a first service node that is in the first data center and is corresponding to a backup node, the management node adjusts, by using a load balancing policy or a hash algorithm or a range merging algorithm and based on the parameter of change of a range mapped by the first service node, range distribution that is mapped by each service node in the first service node and a related second service node in the first data center and is in the routing information, and correspondingly adjusts range distribution that is of at least one backup node in the second data center and is in the routing information, where the at least one backup node is corresponding to the first service node and the second service node.

In an actual application process, a first factor that is used to trigger change in a range mapped by the first service node is acquired. When the first factor is that a new node added, range distribution corresponding to each service node in the at least two service nodes may be adjusted by using the load balancing policy or the hash algorithm. When the first factor is that load of nodes in the first data center is imbalanced, range distribution corresponding to each service node in the at least two service nodes may be adjusted by using the load balancing policy. For example, when a rapid increase in data traffic and an access amount that are corresponding to the node 31 in the data center 1 causes a decrease in work efficiency of the node 31, range distribution separately corresponding to the node 31 and the node 32 is adjusted based on the load balancing policy, so that load of the nodes in the data center 1 achieves a balance. If the first factor is that a node is disconnected, the range distribution corresponding to each service node in the at least two service nodes may be adjusted by using the range merging algorithm. For example, when the node 32 in the data center 1 is disconnected, [A1, B1) mapped by the node 32 and [B1, C1) mapped by the node 33 may be merged, so that the range interval mapped by the node 33 is [A1, B1) and [B1, C1). After the range distribution corresponding to each service node in the at least two service nodes is adjusted, range distribution corresponding to each backup node in the at least one backup node corresponding to the at least two service nodes is correspondingly adjusted.

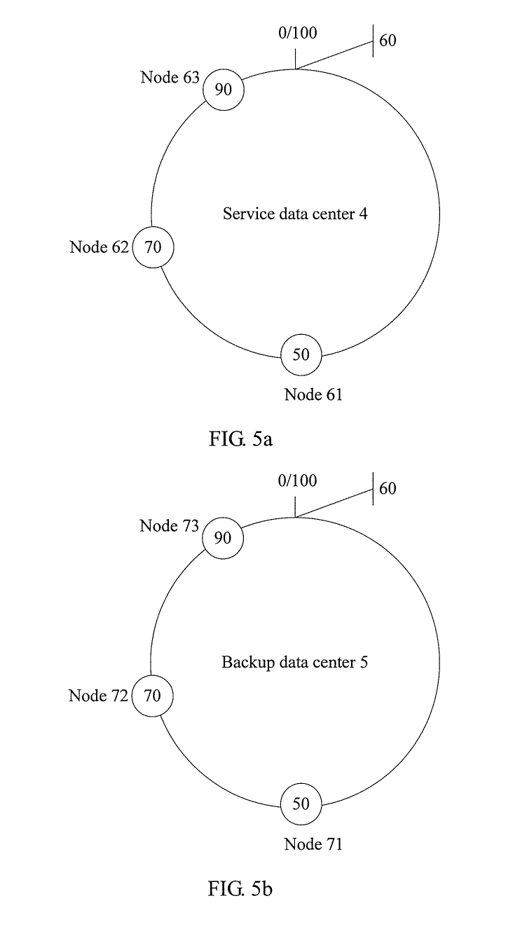

For example, referring to FIG. 5a and FIG. 5b, if the multiple data centers include a service data center 4 that serves as the first data center and a backup data center 5 that serves as the second data center, a node 61, a node 62, and a node 63 included in the service data center 4 are all service nodes, and the service data center 4 map to a DHT ring 60, where a value range of the DHT ring 60 is (0, 100); a node 71, a node 72, and a node 73 included in the backup data center 5 are all backup nodes. Routing table information stored in the management node is shown in the following Table 3, where routing information of the service data center 4 is routing information a, and routing information of the backup data center 5 is routing information b.

TABLE 3

| | | | Related | | | |
|---|---|---|---|---|---|---|
| First identification | Range | Attribute | information of | Related information | | |
| information | distribution | information | a master node | of a slave node | | Backup node information |
| DC4 | [90, 50) | TRUE | Node 61 | Node 62 | Node 63 | (DC5, node 71) |
| (routing information a) | [50, 70) | TRUE | Node 62 | Node 61 | Node 63 | (DC5, node 72) |
| | [70, 90) | TRUE | Node 63 | Node 61 | Node 62 | (DC5, node 73) |
| DC5 | [90, 50) | FALSE | Node 71 | Node 72 | Node 73 | # |
| (routing information b) | [50, 70) | FALSE | Node 72 | Node 71 | Node 73 | # |
| | [70, 90) | FALSE | Node 73 | Node 71 | Node 72 | # |

When a node 64 is added to the service data center 4, because an interval [90, 50) mapped by the node 61 is largest, so that data traffic and an access amount that are corresponding to the node 61 is also largest; therefore, the node 64 may be inserted to a position whose value is within [90, 50) on the DHT ring 60 based on the load balancing policy, so that a range mapped by the node 64 is [90, 20), [90, 40), [90, 30), or the like. When the range interval mapped by the node 64 is [90, 20), the range interval mapped by the node 61 is [20, 50), and range distribution corresponding to the node 71 is correspondingly adjusted. Likewise, when the node 64 is added to the service data center 4, information such as an IP address and/or a domain name of the node 64 may also be hashed based on the hash algorithm, so as to acquire a first key value within a range [0, 100). Then the first key value is mapped to the DHT ring 60, so that the range interval mapped by the node 64 may be determined. For example, when the first key value of the node 64 is 80, the range interval mapped by the node 64 is [70, 80), which results in that the range interval mapped by the node 63 is [80, 90). Then range distribution corresponding to the node 73 is correspondingly adjusted. An example in which a range mapped by the node 64 is [90, 20) is used. Routing information of the service data center 4 and the backup data center 5 is shown in the following Table 4.

TABLE 4

| | | | Related | | | |
|---|---|---|---|---|---|---|
| | | | information | | | |
| First identification | Range | Attribute | of a master | Related information of | | |
| information | distribution | information | node | a slave node | | Backup node information |
| DC4 | [90, 20) | TRUE | Node 64 | Node 62 | Node 63 | (DC5, node 71) |
| (routing information a1) | [20, 50) | TRUE | Node 61 | Node 62 | Node 63 | (DC5, node 71) |
| | [50, 70) | TRUE | Node 62 | Node 61 | Node 63 | (DC5, node 72) |
| | [70, 90) | TRUE | Node 63 | Node 61 | Node 62 | (DC5, node 73) |
| DC5 | [90, 20) | FALSE | Node 71 | Node 72 | Node 73 | # |
| (routing information b1) | [20, 50) | FALSE | Node 71 | Node 72 | Node 73 | # |
| | [50, 70) | FALSE | Node 72 | Node 71 | Node 73 | # |
| | [70, 90) | FALSE | Node 73 | Node 71 | Node 72 | # |

As shown in Table 4, when the node 64 is added to the service data center 4, a range allocated by the management node to the node 64 is [90, 20), the backup node information of the node 64 inherits the backup node information of [90, 50) that includes [90, 20), and the related information of a slave node of the node 64 may further be the node 61 and the node 62, or the node 61 and the node 63, or the node 61, or the node 61 and the node 62 and the node 63, or the like, which is not specifically limited in this embodiment of the present invention. Therefore, the routing information a is adjusted to routing information a1. Because the range distribution of the node 64 and the node 61 change, the range distribution corresponding to the node 71 is correspondingly adjusted, and therefore, the routing information b is adjusted to routing information b1, which may be specifically shown in Table 4.

The following gives another embodiment. When the node 62 is disconnected, a range mapped by the node 63 is [50, 90) based on the range merging algorithm, which is specifically shown in the following Table 5.

TABLE 5

| | | | Related | | | |
|---|---|---|---|---|---|---|
| First | | | information | | | |
| identification | Range | Attribute | of a master | Releated information | | Back up node |
| information | distribution | information | node | of a slave node | | information |
| DC4 | [90, 50) | TRUE | Node 61 | # | Node 63 | (DC5, node 71) |
| (routing | [50, 90) | TRUE | Node 63 | Node 61 | # | (DC5, node 73) |
| information a2) | | | | | | |
| DC5 | [90, 50) | FALSE | Node 71 | # | Node 73 | # |
| (routing | [50, 90) | FALSE | Node 73 | Node 71 | # | # |
| information b2) | | | | | | |

As shown in Table 5, when the node 62 is disconnected, the management node merges the range interval [50, 70) mapped by the node 62 and the range interval [70, 90), and deletes information that includes the node 62 and is in the related information of a slave node in the service data center 4. Therefore, the routing information a is adjusted to routing information a2. The range distribution of the node 72 and the node 73 in the backup data center 5 are correspondingly adjusted, and therefore, the routing information b is adjusted to routing information b2. For details, refer to Table 5.

Specifically, when the parameter in the route update message is a parameter of change of a first backup node in the second data center, the management node acquires a factor corresponding to the parameter of change of the first backup node, where the factor is used to trigger change in the first backup node; when detecting that the factor is that a backup node is disconnected or data is migrated, the management node adjusts, by using a range merging algorithm, range distribution that is corresponding to the first backup node and a related second backup node and is in the routing information, and correspondingly adjusts backup node information that is of each service node in the at least two service nodes and is in the routing information, where the at least two service nodes are service nodes that are corresponding to the first backup node and the second backup node and are in the first data center.

In a specific implementation manner, the factor that is corresponding to the parameter of change of the first backup node and is acquired by the management node may be disconnection of a backup node, data migration, an instruction switchover, or the like. For the data migration, when storage space of a first node in the second data center is fully occupied, the first node needs to be replaced by using another node in the online nodes, where the another node is an online node that is in the second data center and does not map to the DHT ring. For example, referring to FIG. 5b, storage space of the node 71 in the backup data center 5 is fully occupied, and the node 71 is replaced with an online node except the node 72 and the node 73, for example, a node 74, in the backup data center 5, so that the range interval mapped by the node 74 is [90, 50), and data in the node 71 is migrated to the node 74. For the instruction switchover, for example, when a switchover instruction of a user is received, a switchover is performed between the node 71 and the node 72 in the backup data center 5. A specific example in which the node 71 is disconnected is used in the following. Routing information of the service data center 4 and the backup data center 5 is shown in the following Table 6.

TABLE 6

| | | | Related | | | |
|---|---|---|---|---|---|---|
| First | | | information | | | |
| identification | Range | Attribute | of a master | Related information | | Backup node |
| information | distribution | information | node | of a slave node | | information |
| DC4 | [90, 50) | TRUE | Node 61 | Node 62 | Node 63 | (DC5, node 72) |
| (routing | [50, 70) | TRUE | Node 62 | Node 61 | Node 63 | (DC5, node 72) |
| information a3) | [70, 90) | TRUE | Node 63 | Node 61 | Node 62 | (DC5, node 73) |
| DC5 | [90, 50) | FALSE | Node 72 | # | Node 73 | # |
| (routing | [50, 70) | FALSE | Node 72 | # | Node 73 | # |
| information b3) | [70, 90) | FALSE | Node 73 | # | Node 72 | # |

As shown in Table 6, when the node 71 is disconnected, a range interval mapped by the node 72 is adjusted to [90, 50) and [50, 70), and related information that includes the node 71 and is in the related information of a slave node in the backup data center 5 is deleted, so that, the routing information b is adjusted to routing information b3. The backup node information of the node 61 that is corresponding to the node 71 and is in the service data center 4 is correspondingly adjusted, so that the routing information a is adjusted to routing information a3. For details, refer to Table 6.

When the factor is data migration, and the node 71 is replaced with the node 74, [90, 50) is corresponding to the node 74, and related information that includes the node 71 and is in the related information of a slave node in the backup data center 5 is adjusted to related information of the node 74, so that the backup node information of the node 61 is adjusted to (DC5, node 74), so as to acquire the adjusted routing information of the first data center and the second data center.

In addition, when the factor is the instruction switchover, for example, when the node 71 is switched to the node 72, a range interval mapped by the node 72 is [90, 50), a range interval mapped by the node 71 is [50, 70), the related information of a slave node separately corresponding to the node 71 and the node 72 remains unchanged, that is, the related information of a slave node corresponding to the node 71 is still routing information of the node 72 and the node 73, and the backup node information of the node 61 is correspondingly adjusted to (DC5, node 72) and the backup node information of the node 62 is correspondingly adjusted to (DC5, node 71), so as to acquire the adjusted routing information of the first data center and the second data center.

In a specific implementation process, when the parameter in the route update message is a parameter of a range service switchover corresponding to a third service node in the first data center, the management node determines a third backup node that is corresponding to the third service node and is in the second data center; and the management node adjusts, based on the parameter of a range service switchover corresponding to the third service node, attribute information of the third service node in the routing information from first attribute information to second attribute information, deletes routing information of the third backup node from backup node information of the third service node, adjusts attribute information of the third backup node in the routing information from the second attribute information to the first attribute information, and adds routing information of the third service node to backup node information of the third backup node, where the first attribute information is information that is used to indicate that a node is a service node, and the second attribute information is information that is used to indicate that a node is a backup node.

In a specific implementation process, referring to FIG. 5a, an example in which the third service node is the node 62 is used. Then, it may be determined that the third backup node is the node 72 in the data center 5, the attribute information of the node 62 is adjusted from TRUE to FALSE, routing information of the node 72 in the backup node information of the node 62 is deleted, the attribute information corresponding to the node 72 is adjusted from FALSE to TRUE, and routing information of the node 62 is added to the backup node information of the node 72, where the first attribute information is represented by TRUE, and the second attribute information is represented by FALSE. For details, refer to Table 7.

TABLE 7

| | | | Related | | | |
|---|---|---|---|---|---|---|
| First | | | information | | | |
| identification | Range | Attribute | of a master | Related information | | Backup node |
| information | distribution | information | node | of a slave node | | information |
| DC4 | [90, 50) | TRUE | Node 61 | Node 62 | Node 63 | (DC5, node 71) |
| (routing | [50, 70) | FALSE | Node 62 | Node 61 | Node 63 | # |
| information a4) | [70, 90) | TRUE | Node 63 | Node 61 | Node 62 | (DC5, node 73) |
| DC5 | [90, 50) | FALSE | Node 71 | Node 72 | Node 73 | # |
| (routing | [50, 70) | TRUE | Node 72 | Node 71 | Node 73 | (DC4, node 62) |
| information b4) | [70, 90) | FALSE | Node 73 | Node 71 | Node 72 | # |

As shown in Table 7, when a range service switchover is performed, only attribute information and backup node information of the third service node and the third backup node that is corresponding to the third service node need to be modified, and routing information of other nodes in the first data center and the second data center does not need to be modified, so that a cost of a range switchover becomes less. In addition, because the range service switchover is performed between a service node and a backup node, a backup node or a service node in a data center may be particularly selected to perform the range switchover, so that the range switchover becomes more flexible. In addition, a processing manner when a backup node is switched to a service node is the same as that of the foregoing switchover of the node 62 to the node 72, and details are not described herein again.

Because a backup node and a service node in the multiple data centers can be switched to each other, so that the technologies in this specification can also be applied to active-active data centers, where a data structure of a group of data centers that includes any one data center that has a backup node and at least one another data center that is corresponding to the any one data center may be the active-active data center structure. If the structure of the group of data centers is the active-active data center structure, each data center in the group of data centers is a service data center and includes both a service node and a backup node. For details, refer to Table 7.

The foregoing gives separate descriptions when the parameter in the route update message includes one of the parameter of change of a range mapped by a service node that is corresponding to a backup node, the parameter of change of a backup node, and the parameter of a range service switchover corresponding to the backup node or service node. When the parameter in the route update message includes two or three parameters of the parameter of change of a range mapped by a service node that is corresponding to a backup node, the parameter of change of a backup node, and the parameter of a range service switchover corresponding to the backup node or service node, for a specific implementation manner thereof, reference may be made to the foregoing implementation manner used when the parameter in the route update message includes only one of the parameters. An example in which the parameter in the route update message includes three parameters is used in the following for specific description.

For example, referring to FIG. 5a and FIG. 5b, when a node 65 is added to the service data center, and at the same time, the node 63 needs to perform a range service switchover, a range interval allocated by the management node to the node 65 is [90, 30); backup node information of the node 65 inherits the backup node information of [90, 50) that includes [90, 30); related information of a slave node of the node 65 may still be the node 61 and the node 62, or the node 61 and the node 63, or the node 61, or the node 61 and the node 62 and the node 63, or the like, which is not limited in this embodiment of the present invention; attribute information corresponding to the node 63 is adjusted from TRUE to FALSE, the backup node information of the node 63 is deleted, and therefore, the routing information a is adjusted to routing information a5. A range interval mapped by the node 71 is correspondingly adjusted; attribute information of the node 73 is adjusted from FALSE to TRUE; routing information (DC4, node 63) of the node 63 is added to backup node information of the node 73; attribute information of the node 63 is adjusted from TRUE to FALSE, routing information (DC5, node 73) of the node 73 is deleted from the backup node information of the node 63, and therefore, the routing information b is adjusted to routing information b5, which is specifically shown in the following Table 8.

TABLE 8

| First | | | Related | | | |
|---|---|---|---|---|---|---|
| identification | Range | Attribute | information of a | Related information | | Backup node |
| information | distribution | information | master node | of a slave node | | information |
| DC4 | [90, 30) | TRUE | Node 65 | Node 62 | Node 63 | (DC5, node 71) |
| (routing | [30, 50) | TRUE | Node 61 | Node 62 | Node 63 | (DC5, node 71) |
| information | [50, 70) | TRUE | Node 62 | Node 61 | Node 63 | (DC5, node 72) |
| a5) | [70, 90) | FALSE | Node 63 | Node 61 | Node 62 | # |
| DC5 | [90, 30) | FALSE | Node 71 | Node 72 | Node 73 | # |
| (routing | [30, 50) | FALSE | Node 71 | Node 72 | Node 73 | # |
| information | [50, 70) | FALSE | Node 72 | Node 71 | Node 73 | # |
| b5) | [70, 90) | TRUE | Node 73 | Node 71 | Node 72 | (DC4, node 63) |

After step S402 is performed, step S403 is performed subsequently. The management node synchronizes the adjusted routing information of the first data center and the second data center to the first data center and the second data center, so that the first data center and the second data center perform, based on the adjusted routing information, synchronous transmission on data of the managed nodes.

In a specific implementation process, after the adjusted routing information of the first data center and the second data center is acquired in S402, the management node synchronizes adjusted first routing information of the first data center to the first data center, and synchronizes adjusted second routing information of the second data center to the second data center, so that the first data center performs, based on the adjusted first routing information, synchronous transmission on data of the managed nodes, and the second data center performs, based on the adjusted second routing information, synchronous transmission on data of the managed nodes.

For example, referring to Table 3 and Table 4, after the node 64 is added to the service data center 4, when the service data center 4 receives the routing information a1 sent by the management node, the service data center 4 synchronizes data in the node 61 to the node 64 based on the routing information a1, thereby implementing synchronization of data between the nodes. Likewise, when the backup data center 5 receives the routing information b1 sent by the management node, the backup data center 5 may determine, based on the routing information b1, that change in the backup data center 5 is only that the range interval [90, 50) mapped by the node 71 is divided into a range interval [90, 20) and a range interval [20, 50), which results in that no data in the backup data center 5 needs to be synchronized, and therefore, a data synchronization operation is not performed between the nodes included in the backup data center 5.

For example, referring to Table 3 and Table 5, after the node 62 is disconnected, and when the service data center 4 receives the routing information a2 sent by the management node, the service data center 4 modifies the backup node information of the node 63 to the node 73 based on the routing information a2, so that data in the node 63 and data in the node 73 are synchronized. Likewise, when the backup data center 5 receives the routing information b2 sent by the management node, the backup data center 5 synchronizes data in the node 72 to the node 73 based on the routing information b2, so that the node 63 can directly copy the data in the node 73, and data synchronization between the node 63 and the node 73 is implemented.

For example, referring to Table 3 and Table 6, after the node 71 is disconnected, and when the backup data center 5 receives the routing information b3 sent by the management node, the backup data center 5 adjusts a master node of the range interval [90,50) to the node 72 based on the b3 routing information, so as to synchronize the data in the node 61 to the node 72, thereby implementing data synchronization between the node 61 and the node 72. Likewise, when the service data center 4 receives the routing information a3 sent by the management node, the service data center 4 controls, based on the routing information a3 and according to the backup node information corresponding to the node 61, the data in the node 61 to be directly sent to the node 72, thereby implementing data synchronization between the node 61 and the node 72.

For example, referring to Table 3 and Table 7, after the backup node 72 performs a range service switchover, when the backup data center 5 receives the routing information b4 sent by the management node, based on the backup node information (DC4, node 62) that is corresponding to the node 72 and is in the routing information b4, the node 72 directly copies data in the node 62, thereby implementing data synchronization between the node 72 and the node 62. When the service data center 4 receives the routing information a4 sent by the management node, it may be determined that change in the service data center 4 is only that the attribute information corresponding to the node 62 is adjusted from TRUE to FALSE, which results in that no data in the service data center 4 needs to be synchronized, and therefore, a data synchronization operation is not performed between the nodes included in the service data center 4.

In the multiple data centers in this embodiment, data is transmitted not by using a transit node, but is directly transmitted between correlated nodes, thereby avoiding a bottleneck effect of the multiple data centers during synchronous transmission of data, so that efficiency of the synchronous transmission of data becomes higher.

In another embodiment, the management node may acquire only a first route update message that instructs to update routing information of the first data center, the management node adjusts first routing information of the first data center according to the first route update message, and the management node synchronizes adjusted first routing information of the first data center to the first data center, so that the first data center performs, based on the adjusted first routing information, synchronous transmission on data of the managed nodes.

Certainly, the management node may acquire only a second route update message that instructs to update routing information of the second data center, the management node adjusts second routing information of the second data center according to the second route update message, and the management node synchronizes adjusted second routing information of the second data center to the second data center, so that the second data center performs, based on the adjusted second routing information, synchronous transmission on data of the managed nodes.

In a specific implementation process, cases in which a slave node of any one node in the first data center changes, and range distribution of a service node that does not have a corresponding backup node changes may result in that the management node acquires the first route update message. Likewise, cases in which a slave node of any one node in the second data center changes, and range distribution of a service node that does not have a corresponding backup node changes may result in that the management node acquires the second route update message.

For example, referring to Table 1, when storage space of the node 31 in the data center 1 is fully occupied, and the node 31 needs to be replaced with the node 37, where the node 37 is an online node in the data center 1, a replace request is sent to the management node, so that the management node can receive the first route update message. Then the management node adjusts first routing information of the data center 1 based on the first route update message. The management node adjusts the related information of a master node corresponding to [F1, A1) from the node 31 to the node 37, and sends adjusted routing information of the data center 1 to the data center 1, so that the data center 1 synchronizes, based on the adjusted routing information of the data center 1, data in the node 37 with data in the node 31.

For another example, referring to Table 1, in the data center 1, when a slave node of the node 32 needs to be adjusted from the node 31 and the node 33 to the node 34, a request for adjusting a slave node is sent to the management node, so that the management node can receive the first route update message. Then the management node adjusts, based on the first route update message, first routing information of the data center 1. The management node adjusts the slave node of the node 32 from the node 31 and the node 33 to the node 34, and sends adjusted routing information of the data center 1 to the data center 1, so that the data center 1 backs up, based on the adjusted routing information of the data center 1, data in the node 32 to the node 34, and deletes data that is in the node 32 and is backed up in the node 31 and the node 33.

In addition, referring to Table 1, when the node 38 is added to an interval [D1, E1) of the DHT ring 30, a range interval mapped by the node 38 is [D1, G1), and a range interval mapped by the node 35 is [G1, E1). Because a master node of [D1, E1) does not have a backup node, so that the management node needs to adjust only the first routing information of the data center 1, and then synchronizes adjusted first routing information of the data center 1 to the data center 1.

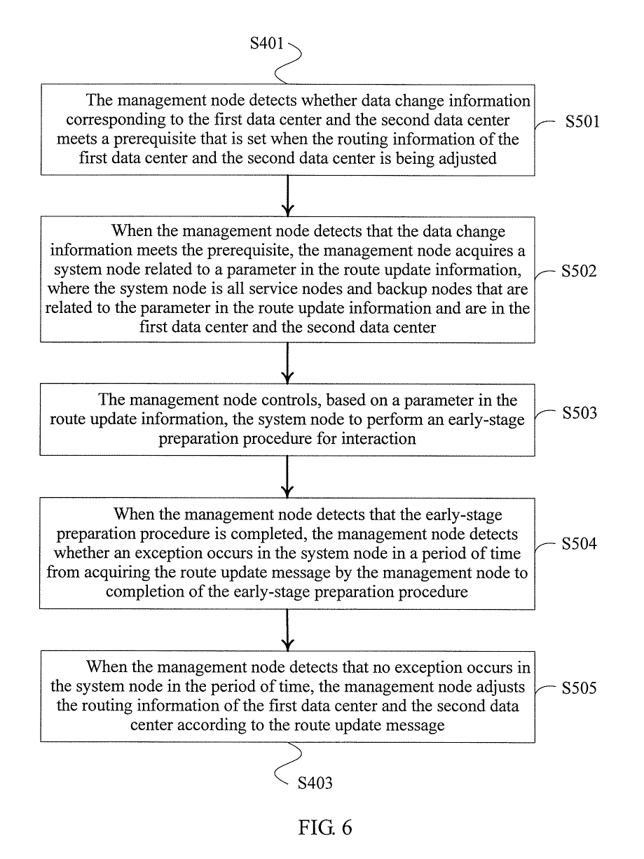

In another embodiment, referring to FIG. 6, after step S401 is performed, step S402 includes step S501 to step S505, which indicates that step S403 is performed after step S505 is performed, and specific description is given in the following.

After acquiring the route update message, the management node performs step S501: The management node detects whether data change information corresponding to the first data center and the second data center meets a prerequisite that is set when the routing information of the first data center and the second data center is being adjusted.

In a specific implementation process, after acquiring the data change information, the management node detects whether the data change information meets the prerequisite; when the prerequisite is met, step S502 is performed; when the prerequisite is not met, step S502 is not performed until it is detected that the data change information meets the prerequisite.

The data change information refers to route change information of all nodes in the first data center and the second data center, and the prerequisite is set according to the route update message. For example, referring to Table 4, when the node 64 is added to the service data center 4, the range interval allocated by the management node to the node 64 is [90, 20), and the prerequisite is that the range interval [90, 50) that includes the range interval [90, 20) and is in the service data center 4 is not changed. If the range interval [90, 50) that includes the range interval [90, 20) and is in the service data center 4 is changed due to the load balancing policy or disconnection of the node 61, the data change information does not meet the prerequisite. If the data change information of the service data center 4 indicates that the range interval [90, 50) is not changed, it may be determined that the data change information meets the prerequisite.

In addition, as shown in Table 4, when the range interval [90, 50) and the range interval [50, 70) in the service data center 4 are merged, the prerequisite is that the range interval [90, 50) and the range interval [50, 70) in the service data center 4 is not changed. If a new node is added to the service data center 4, the range interval [90, 50) needs to be divided, resulting in that the range interval [90, 50) is changed, so that the data change information does not meet the prerequisite. The data change information meets the prerequisite only when the range interval [90, 50) and the range interval [50, 70) in the service data center 4 are not changed.

When detecting that the data change information meets the prerequisite, the management node performs step S502: The management node acquires a system node related to the parameter in the route update message, where the system node is all service nodes and backup nodes that are related to the parameter in the route update message and are in the first data center and the second data center.

For example, referring to Table 4, when the node 64 is added to the service data center 4, it may be obtained by querying Table 4 that the system node is the node 61 and the node 71. For another example, referring to Table 6, when the node 71 is disconnected, it may be obtained by querying Table 6 that the system node is the node 72 and the node 61.

In another embodiment, when the management node detects that the data change information meets the prerequisite, the management node may directly adjust the routing information of the first data center and the second data center according to the route update message.

After step S502 is performed, the management node subsequently performs step S503: The management node controls, based on a parameter in the route update message, the system node to perform an early-stage preparation procedure for interaction.

In a specific implementation process, the early-stage preparation procedure is determined based on the parameter in the route update message, and a different parameter in the route update message indicates a different early-stage preparation procedure. For example, when the parameter in the route update message is the parameter of change of a range mapped by a service node that is corresponding to a backup node, and the parameter of change of a range mapped by the service node is caused due to that a new node is added, range intervals mapped by an immigration node and an emigration node need to be locked. When the parameter in the route update message is the parameter of change of a range mapped by a service node that is corresponding to a backup node, and the parameter of change of a range mapped by the service node is caused by disconnection of a node, a merged range interval and a merging range interval need to be locked. When the parameter in the route update message is the parameter of a range service switchover mapped by the backup node or the service node, only a range interval of the backup node and a range interval of a service node corresponding to the backup node need to be locked.

For example, referring to Table 4, when the node 64 is added to the service data center 4, because a range interval allocated to the node 64 is [90, 20), the node 61 needs to lock the range interval [90, 20), and when the range interval [90, 20) is locked, any request operation from a user is not responded to.

In another embodiment, when the early-stage preparation procedure is completed, the routing information of the first data center and the second data center may be directly adjusted according to the route update message.

When detecting that the early-stage preparation procedure is completed, the management node performs step S504: Detect whether an exception occurs in the system node in a period of time from acquiring the route update message by the management node to completion of the early-stage preparation procedure.

Specifically, the exception is caused by reasons such as: service unavailability due to a breakdown of a service data center, a power failure, and the like; a data exception of a range of a service data center; and range service switchover performed according to some principles such as access delay minimization. If no exception occurs in a period of time, for example, 3 seconds or 5 seconds, during which step S401 to step S503 are performed, step S505 is performed; otherwise, step S505 is not performed, and steps from S401 are performed again after a specific time interval, for example, 30 seconds or 60 seconds.

When detecting that no exception occurs in the system node in the period of time, the management node performs step S505: Adjust the routing information of the first data center and the second data center according to the route update message. After step S505 is performed, step S403 is performed.

In another embodiment, all service nodes in the multiple data centers may map to a part of a DHT ring. For details, refer to FIG. 3a. For example, if a range mapped by the service node 31 is [0, A1), the multiple data centers map to [0, F1) of the DHT ring 30.

In this embodiment of the present invention, a management node adjusts routing information of a first data center and a second data center only when a route update message that instructs to update the routing information of the first data center and the second data center is acquired, and then data synchronization between the first data center and the second data center is performed based on adjusted routing information of the first data center and the second data center. In this way, data synchronization between the first data center and the second data center can be implemented only when the foregoing restrictive condition is met, thereby ensuring sealability between data centers in multiple data centers. Besides, data is transmitted not by using a transit node, but is directly transmitted between correlated nodes, thereby avoiding a bottleneck effect of the multiple data centers during synchronous transmission of data, so that efficiency of the synchronous transmission of data becomes higher.

### Embodiment 2

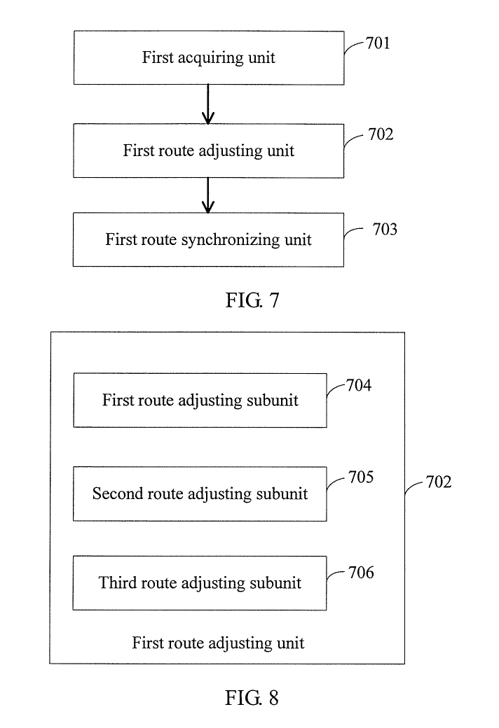

Embodiment 2 of the present invention proposes a data synchronization apparatus. Referring to FIG. 7 and FIG. 8, the data synchronization apparatus is separately communicatively connected to each data center in multiple data centers, the multiple data centers include at least two data centers, each data center in the at least two data centers includes at least two nodes, all service nodes in the at least two data centers map to one distributed hash table DHT ring, each consecutive value range in the DHT ring is corresponding to a service node, a service node in a first data center in the at least two data centers has at least one backup node that is in at least one second data center in the at least two data centers and whose data interval distribution is corresponding to that of the service node, and the data synchronization apparatus includes:

a first acquiring unit 701, configured to acquire a route update message that instructs to update routing information of the first data center and the second data center, where the routing information includes at least identification information of the first data center and the second data center, and backup routing information of nodes in the first data center and the second data center;

a first route adjusting unit 702, configured to receive the route update message from the first acquiring unit 701 and adjust the routing information of the first data center and the second data center according to the route update message; and

a first route synchronizing unit 703, configured to receive adjusted routing information that is of the first data center and the second data center and is from the first route adjusting unit 702, and synchronize the adjusted routing information of the first data center and the second data center to the first data center and the second data center, so that the first data center and the at least one second data center perform, based on the routing information, synchronous transmission on data of managed nodes.

Because the multiple data centers are constructed based on a distributed system, so that all the service nodes in the at least two data centers map to one DHT ring, each consecutive value range (range) in the DHT ring is corresponding to a service node, and a service node in the first data center in the at least two data centers has at least one backup node that is in the at least one second data center in the at least two data centers and whose data interval distribution is corresponding to that of the service node.

For example, referring to FIG. 3c, the node 52 may map to [E1, F1) and [D1, E1), and the node 51 may map to three ranges [C1, D1), [B1, C1), and [A1, B1), which results in that the node 52 is separately corresponding to the node 35 and the node 36, and the node 51 is corresponding to the node 31, the node 32, and the node 33, so that one backup node may be corresponding to several service nodes.

Specifically, each data center in the multiple data centers is a service data center or a backup data center, and a structure of the first data center and the second data center may be a service data center-backup data center structure or an active-active data center structure. If a structure of a group of data centers in the multiple data centers is the service data center-backup data center structure, each service data center in the group of data centers includes only service nodes, and each backup data center in the group of data centers includes only backup nodes. If a structure of a group of data centers in the multiple data centers is the active-active data center structure, each data center in the group of data centers is a service data center and includes both a service node and a backup node.

In a specific implementation process, a data structure between nodes included in any one data center in the multiple data centers is a master node-slave node structure, any one node and a slave node corresponding to the any one node are nodes in a same data center, and the slave node is used to back up data in the any one node.

For example, referring to FIG. 3a, FIG. 3b, and FIG. 3c, range distribution of a data center 2 is divided according to range distribution of a data center 1, and range distribution of a data center 3 is also divided according to the range distribution of the data center 1, so that the data center 1 has a data center 2 and a data center 3 whose data interval distribution is corresponding to that of the data center 1.

Specifically, the data synchronization apparatus includes a storage unit, configured to store routing table information of each data center in the multiple data centers, where the routing table information includes identification information uniquely corresponding to each data center and routing information of each data center.

Specifically, the backup routing information includes range information corresponding to a node, attribute information indicating that the node is a service node or a backup node, and backup node information of the node, where when the node is a service node, the backup node information of the node is routing information of a backup node that is used to back up data in the node.

Preferably, in order to better manage the routing information of each data center in the multiple data centers, the routing information of each data center may further include routing number information. For example, routing number information of the data center 1 shown in Table 1 is represented, for example, by a number 10 or a character “a”. When identification information of the data center 1 is changed from DC1 to DC4, the routing number information of the data center 1 is adjusted from the number 10 to a number 11, or adjusted from the character “a” to a character “b”, so that the data synchronization apparatus can determine, by using only the routing number information of the data center 1, whether routing information of each node in all the nodes included in the data center 1 is latest routing information.

Preferably, routing information of any one data center in the multiple data centers further includes online node information, and/or failed node information, and/or temporary backup node information of the data center.

Specifically, the first route adjusting unit 702 is specifically configured to adjust the backup routing information in the routing information of the first data center and the second data center according to a parameter in the route update message, where the parameter in the route update message includes one or any combination of a parameter of change of a range mapped by a service node that is corresponding to a backup node, a parameter of change of a backup node, and a parameter of a range service switchover corresponding to a backup node or service node, where the parameter of a range service switchover corresponding to the backup node or service node is a parameter that is used to indicate that the backup node or the service node serves as a service node or a backup node.

The parameter of a range service switchover corresponding to the backup node is a parameter that is used to indicate that the backup node is switched to a service node, and the parameter of a range service switchover corresponding to the service node is a parameter that is used to indicate that the service node is switched to a backup node.

Specifically, the first route adjusting unit 702 includes a first route adjusting subunit 704, configured to: when the parameter in the route update message is a parameter of change of a range mapped by a first service node that is in the first data center and is corresponding to a backup node, adjust, by using a load balancing policy or a hash algorithm or a range merging algorithm and based on the parameter of change of a range mapped by the first service node, range distribution that is mapped by each service node in the first service node and a related second service node in the first data center and is in the routing information, and correspondingly adjust range distribution that is of at least one backup node in the second data center and is in the routing information, where the at least one backup node is corresponding to the first service node and the second service node.

Specifically, the first route adjusting unit 702 includes a second route adjusting subunit 705, configured to: when the parameter in the route update message is a parameter of change of a first backup node in the second data center, acquire a factor corresponding to the parameter of change of the first backup node, where the factor is used to trigger change in the first backup node; and when it is detected that the factor is that a backup node is disconnected or data is migrated, adjust, by using a range merging algorithm, range distribution that is corresponding to the first backup node and a related second backup node and is in the routing information, and correspondingly adjust backup node information that is of each service node in at least two service nodes and is in the routing information, where the at least two service nodes are service nodes that are corresponding to the first backup node and the second backup node and are in the first data center.

Specifically, the first route adjusting unit 702 includes a third route adjusting subunit 706, configured to: when the parameter in the route update message is a parameter of a range service switchover corresponding to a third service node in the first data center, determine a third backup node that is corresponding to the third service node and is in the second data center, adjust, based on the parameter of a range service switchover corresponding to the third service node, attribute information of the third service node in the routing information from first attribute information to second attribute information, delete routing information of the third backup node from backup node information of the third service node, adjust attribute information of the third backup node in the routing information from the second attribute information to the first attribute information, and add routing information of the third service node to backup node information of the third backup node, where the first attribute information is information that is used to indicate that a node is a service node, and the second attribute information is information that is used to indicate that a node is a backup node.

Specifically, the data synchronization apparatus further includes a first detecting unit, configured to: after the first acquiring unit 701 acquires the route update message, and before the first route adjusting unit 702 adjusts the routing information of the first data center and the second data center, detect whether data change information corresponding to the first data center and the second data center meets a prerequisite that is set when the routing information of the first data center and the second data center is being adjusted.

Specifically, the data synchronization apparatus includes an early-stage preparing unit, configured to: when information, sent by the first detecting unit, that the data change information meets the prerequisite is received, acquire, from the first data center and the second data center, a system node related to the parameter in the route update message, where the system node is all services nodes and backup nodes that are related to the parameter in the route update message and are in the first data center and the second data center, and control, based on the parameter in the route update message, the system node to perform an early-stage preparation procedure for interaction.

Specifically, the data synchronization apparatus includes a second detecting unit, configured to: when information, sent by the early-stage preparation unit, that the early-stage preparing procedure is completed is received, detect whether an exception occurs in the system node in a period of time from acquiring the route update message by the management node to completion of the early-stage preparation procedure.

When the second detecting unit detects that no exception occurs in the system node in the period of time, the first route adjusting unit 702 receives the route update message from the first acquiring unit 701, and is configured to adjust the routing information of the first data center and the second data center according to the route update message.

In another embodiment, the management node may acquire only a first route update message that instructs to update routing information of the first data center, the management node adjusts first routing information of the first data center according to the first route update message, and the management node synchronizes adjusted first routing information of the first data center to the first data center, so that the first data center performs, based on the adjusted first routing information, synchronous transmission on data of managed nodes.

Certainly, the management node may acquire only a second route update message that instructs to update routing information of the second data center, the management node adjusts second routing information of the second data center according to the second route update message, and the management node synchronizes adjusted second routing information of the second data center to the second data center, so that the second data center performs, based on the adjusted second routing information, synchronous transmission on data of managed nodes.

In this embodiment of the present invention, a management node adjusts routing information of a first data center and a second data center only when a route update message that instructs to update the routing information of the first data center and the second data center is acquired, and then data synchronization between the first data center and the second data center is performed based on the adjusted routing information of the first data center and the second data center. In this way, data synchronization between the first data center and the second data center can be implemented only when the foregoing restrictive condition is met, thereby ensuring sealability between data centers in multiple data centers. Besides, data is transmitted not by using a transit node, but is directly transmitted between correlated nodes, thereby avoiding a bottleneck effect of the multiple data centers during synchronous transmission of data, so that efficiency of the synchronous transmission of data becomes higher.

### Embodiment 3

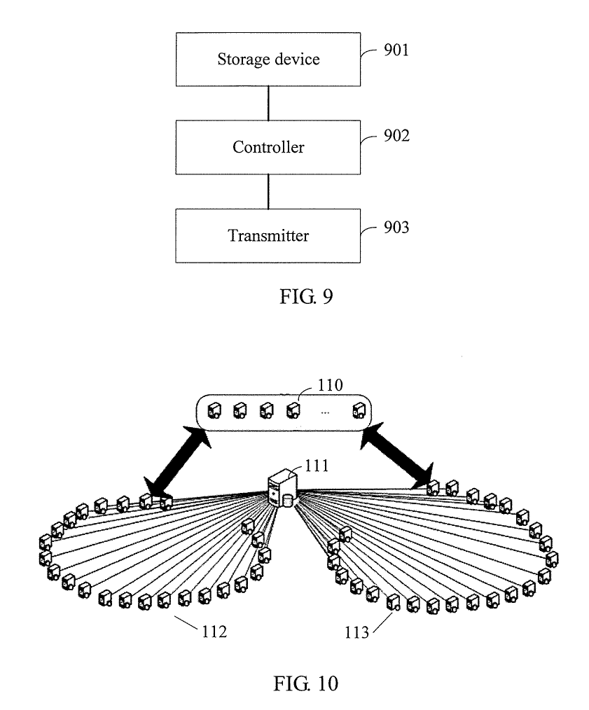

Embodiment 3 of the present invention proposes a data synchronization apparatus. Referring to FIG. 9, the data synchronization apparatus is separately communicatively connected to each data center in multiple data centers, the multiple data centers include at least two data centers, each data center in the at least two data centers includes at least two nodes, all service nodes in the at least two data centers map to one distributed hash table DHT ring, each consecutive value range in the DHT ring is corresponding to a service node, a service node in a first data center in the at least two data centers has at least one backup node that is in at least one second data center in the at least two data centers and whose data interval distribution is corresponding to that of the service node, and the data synchronization apparatus includes:

a storage device 901, configured to store routing table information of each data center in the multiple data centers, where the routing table information includes identification information uniquely corresponding to each data center and routing information of each data center;

a controller 902, configured to: acquire a route update message that instructs to update routing information of the first data center and the second data center, where the routing information includes at least identification information of the first data center and the second data center, and backup routing information of nodes in the first data center and the second data center, and adjust the routing information of the first data center and the second data center according to the route update message; and a transmitter 903, configured to synchronize adjusted routing information of the first data center and the second data center to the first data center and the second data center, so that the first data center and the second data center perform, based on the adjusted routing information, synchronous transmission on data of managed nodes.

The storage device 901 is an electronic device such as a mechanical hard disk and a solid-state disk. Further, the controller 902 is an electronic device such as a CPU and a single-chip microcomputer. Further, the transmitter 903 is an electronic device such as a wireless network interface card, a data transport interface.

Specifically, because the multiple data centers are constructed based on a distributed system, so that all the service nodes in the at least two data centers map to one DHT ring, each consecutive value range (range) in the DHT ring is corresponding to a service node, and a service node in the first data center in the at least two data centers has at least one backup node that is in the at least one second data center in the at least two data centers and whose data interval distribution is corresponding to that of the service node.

Each backup node in the multiple data centers is corresponding to at least one service node, and a service node may have multiple backup nodes that are corresponding to the service node.

Specifically, each data center in the multiple data centers is a service data center or a backup data center, and a structure of the first data center and the second data center is a service data center-backup data center structure or an active-active data center structure. If a structure of a group of data centers in the multiple data centers is the service data center-backup data center structure, each service data center in the group of data centers includes only service nodes, and each backup data center in the group of data centers includes only backup nodes. If a structure of a group of data centers in the multiple data centers is the active-active data center structure, each data center in the group of data centers is a service data center and includes both a service node and a backup node.

In a specific implementation process, a data structure between nodes included in any one data center in the multiple data centers is a master node-slave node structure, any one node and a slave node corresponding to the any one node are nodes in a same data center, and the slave node is used to back up data in the any one node.

For example, referring to Table 1 and Table 2, range distribution of a data center 2 is divided according to range distribution of a data center 1, so that the data center 1 has a data center 2 whose data interval distribution is corresponding to that of the data center 1.

Specifically, the backup routing information includes range information corresponding to a node, attribute information indicating that the node is a service node or a backup node, and backup node information of the node, where when the node is a service node, the backup node information of the node is routing information of a backup node that is used to back up data in the node.

Specifically, the controller 902 is specifically configured to adjust the backup routing information in the routing information of the first data center and the second data center according to a parameter in the route update message, where the parameter in the route update message includes one or any combination of a parameter of change of a range mapped by a service node that is corresponding to a backup node, a parameter of change of a backup node, and a parameter of a range service switchover corresponding to a backup node or service node, where the parameter of a range service switchover corresponding to the backup node or service node is a parameter that is used to indicate that the backup node or the service node serves as a service node or a backup node.

The parameter of a range service switchover corresponding to the backup node is a parameter that is used to indicate that the backup node is switched to a service node, and the parameter of a range service switchover corresponding to the service node is a parameter that is used to indicate that the service node is switched to a backup node.

Preferably, routing information of any one data center in the multiple data centers further includes online node information, and/or failed node information, and/or temporary backup node information of the data center.

Specifically, the controller 902 is further configured to: when the parameter in the route update message is a parameter of change of a range mapped by a first service node that is in the first data center and is corresponding to a backup node, adjust, by using a load balancing policy or a hash algorithm or a range merging algorithm and based on the parameter of change of a range mapped by the first service node, range distribution that is mapped by each service node in the first service node and a related second service node in the first data center and is in the routing information, and correspondingly adjust range distribution that is of at least one backup node in the second data center and is in the routing information, where the at least one backup node is corresponding to the first service node and the second service node.

Preferably, the controller 902 is further configured to: when the parameter in the route update message is a parameter of change of a first backup node in the second data center, acquire a factor corresponding to the parameter of change of the first backup node, where the factor is used to trigger change in the first backup node; and when it is detected that the factor is that a backup node is disconnected or data is migrated, adjust, by using a range merging algorithm, range distribution that is corresponding to the first backup node and a related second backup node and is in the routing information, and correspondingly adjust backup node information that is of each service node in at least two service nodes and is in the routing information, where the at least two service nodes are service nodes that are corresponding to the first backup node and the second backup node and are in the first data center.

Specifically, the controller 902 is further configured to: when the parameter in the route update message is a parameter of a range service switchover corresponding to a third service node in the first data center, determine a third backup node that is corresponding to the third service node and is in the second data center, adjust, based on the parameter of a range service switchover corresponding to the third service node, attribute information of the third service node in the routing information from first attribute information to second attribute information, delete routing information of the third backup node from backup node information of the third service node, adjust attribute information of the third backup node in the routing information from the second attribute information to the first attribute information, and add routing information of the third service node to backup node information of the third backup node, where the first attribute information is information that is used to indicate that a node is a service node, and the second attribute information is information that is used to indicate that a node is a backup node.

Specifically, the controller 902 is further configured to: after the route update message is acquired, and before the routing information of the first data center and the second data center is adjusted according to the route update message, detect whether data change information corresponding to the first data center and the second data center meets a prerequisite that is set when the routing information of the first data center and the second data center is being adjusted.

Specifically, the controller 902 is further configured to: when the data change information meets the prerequisite, acquire, from the first data center and the second data center, a system node related to the parameter in the route update message, where the system node is all services nodes and backup nodes that are related to the parameter in the route update message and are in the first data center and the second data center, and control, based on the parameter in the route update message, the system node to perform an early-stage preparation procedure for interaction.

The system node may be obtained by querying the routing table information stored in the storage device 901, so as to reduce a time required for acquiring the system node.

Specifically, the controller 902 is further configured to: when the early-stage preparation procedure is completed, detect whether an exception occurs in the system node in a period of time from acquiring the route update message by the management node to completion of the early-stage preparation procedure, and when no exception occurs in the period of time, adjust the routing information of the first data center and the second data center according to the route update message.

In another embodiment, the management node may acquire only a first route update message that instructs to update routing information of the first data center, the management node adjusts first routing information of the first data center according to the first route update message, and the management node synchronizes adjusted first routing information of the first data center to the first data center, so that the first data center performs, based on the adjusted first routing information, synchronous transmission on data of managed nodes.

Certainly, the management node may acquire only a second route update message that instructs to update routing information of the second data center, the management node adjusts second routing information of the second data center according to the second route update message, and the management node synchronizes adjusted second routing information of the second data center to the second data center, so that the second data center performs, based on the adjusted second routing information, synchronous transmission on data of managed nodes.

In this embodiment of the present invention, a management node adjusts routing information of a first data center and a second data center only when a route update message that instructs to update the routing information of the first data center and the second data center is acquired, and then data synchronization between the first data center and the second data center is performed based on the adjusted routing information of the first data center and the second data center. In this way, data synchronization between the first data center and the second data center can be implemented only when the foregoing restrictive condition is met, thereby ensuring sealability between data centers in multiple data centers. Besides, data is transmitted not by using a transit node, but is directly transmitted between correlated nodes, thereby avoiding a bottleneck effect of the multiple data centers during synchronous transmission of data, so that efficiency of the synchronous transmission of data becomes higher.

### Embodiment 4

Embodiment 4 of the present invention proposes a distributed system, including:

multiple data centers, including at least two data centers, where each data center in the at least two data centers includes at least two nodes, all service nodes in the at least two data centers map to one distributed hash table DHT ring, each consecutive value range in the DHT ring is corresponding to a service node, and a service node in a first data center in the at least two data centers has at least one backup node that is in at least one second data center in the at least two data centers and whose data interval distribution is corresponding to that of the service node; and

a management node, communicatively connected to each data center in the multiple data centers, configured to acquire a route update message that instructs to update routing information of the first data center and the second data center, where the routing information includes at least identification information of the first data center and the second data center, and backup routing information of nodes in the first data center and the second data center; adjust the routing information of the first data center and the second data center according to the route update message; and synchronize adjusted routing information of the first data center and the second data center to the first data center and the second data center, so that the first data center and the second data center perform, based on the adjusted routing information, synchronous transmission on data of managed nodes.

Specifically, referring to FIG. 10, a management node 111 is separately communicatively connected to each node in a data center 112, and separately communicatively connected to each node in a data center 113. Multiple user terminals 110 may send request information to the data center 112 and the data center 113, and the data center 112 and the data center 113 return data corresponding to the request information to the multiple user terminals 110. When a first user terminal in the multiple user terminals 110 sends first request information to the data center 112, the data center 112 may designate, according to a principle of proximity, a first node for the first user terminal to respond to the first request information, so as to reduce a delay and provide better experience for users.

When backup nodes in the data center 113 are used to back up data in service nodes in the data center 112, if a backup node in the data center 113 is disconnected and data in the backup node needs to be migrated to another backup node, the data center 113 sends, to the management node 111, a route update message that is used to instruct to update routing information of the data center 112 and the data center 113. The management node 111 adjusts the routing information of the data center 112 and the data center 113 according to the route update message, synchronizes adjusted routing information of the data center 112 to the data center 112, and synchronizes adjusted routing information of the data center 113 to the data center 113, so that the data center 112 performs, based on the adjusted routing information of the data center 112, synchronous transmission on data of managed nodes, and the data center 113 performs, based on the adjusted routing information of the data center 113, synchronous transmission on data of the managed nodes.

The backup routing information includes range information corresponding to a node, attribute information indicating that the node is a service node or a backup node, and backup node information of the node, where when the node is a service node, the backup node information of the node is routing information of a backup node that is used to back up data in the node.

Specifically, the management node is specifically configured to adjust the backup routing information in the routing information of the first data center and the second data center according to a parameter in the route update message, where the parameter in the route update message includes one or any combination of a parameter of change of a range mapped by a service node that is corresponding to a backup node, a parameter of change of a backup node, and a parameter of a range service switchover corresponding to a backup node or service node, where the parameter of a range service switchover corresponding to the backup node or service node is a parameter that is used to indicate that the backup node or the service node serves as a service node or a backup node.

The parameter of a range service switchover corresponding to the backup node is a parameter that is used to indicate that the backup node is switched to a service node, and the parameter of a range service switchover corresponding to the service node is a parameter that is used to indicate that the service node is switched to a backup node.

Specifically, the management node is further configured to: when the parameter in the route update message is a parameter of change of a range mapped by a first service node that is in the first data center and is corresponding to a backup node, adjust, by using a load balancing policy or a hash algorithm or a range merging algorithm and based on the parameter of change of a range mapped by the first service node, range distribution that is mapped by each service node in the first service node and a related second service node in the first data center and is in the routing information, and correspondingly adjust range distribution that is of at least one backup node in the second data center and is in the routing information, where the at least one backup node is corresponding to the first service node and the second service node.

Specifically, the management node is further configured to: when the parameter in the route update message is a parameter of change of a first backup node in the second data center, acquire a factor corresponding to the parameter of change of the first backup node, where the factor is used to trigger change in the first backup node; and when it is detected that the factor is that a backup node is disconnected or data is migrated, adjust, by using a range merging algorithm, range distribution that is corresponding to the first backup node and a related second backup node and is in the routing information, and correspondingly adjust backup node information that is of each service node in at least two service nodes and is in the routing information, where the at least two service nodes are service nodes that are corresponding to the first backup node and the second backup node and are in the first data center.

Specifically, the management node is further configured to: when the parameter in the route update message is a parameter of a range service switchover corresponding to a third service node in the first data center, determine a third backup node that is corresponding to the third service node and is in the second data center, adjust, based on the parameter of a range service switchover corresponding to the third service node, attribute information of the third service node in the routing information from first attribute information to second attribute information, delete routing information of the third backup node from backup node information of the third service node, adjust attribute information of the third backup node in the routing information from the second attribute information to the first attribute information, and add routing information of the third service node to backup node information of the third backup node, where the first attribute information is information that is used to indicate that a node is a service node, and the second attribute information is information that is used to indicate that a node is a backup node.

Specifically, the management node is further configured to store routing table information of each data center in the multiple data centers, where the routing table information includes identification information uniquely corresponding to each data center and routing information of each data center.

In this embodiment of the present invention, a management node adjusts routing information of a first data center and a second data center only when a route update message that instructs to update the routing information of the first data center and the second data center is acquired, and then data synchronization between the first data center and the second data center is performed based on adjusted routing information of the first data center and the second data center. In this way, data synchronization between the first data center and the second data center can be implemented only when the foregoing restrictive condition is met, thereby ensuring seal ability between data centers in multiple data centers. Besides, data is transmitted not by using a transit node, but is directly transmitted between correlated nodes, thereby avoiding a bottleneck effect of multiple data centers during synchronous transmission of data, so that efficiency of the synchronous transmission of data becomes higher.

A person skilled in the art should understand that the embodiments of the present invention may be provided as a method, an apparatus (device), or a computer program product. Therefore, the present invention may use a form of hardware only embodiments, software only embodiments, or embodiments with a combination of software and hardware. Moreover, the present invention may use a form of a computer program product that is implemented on one or more computer-usable storage media (including but not limited to a disk memory, a CD-ROM, an optical memory, and the like) that include computer-usable program code.

The present invention is described with reference to the flowcharts and/or block diagrams of the method, the apparatus (device), and the computer program product according to the embodiments of the present invention. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may also be stored in a computer readable memory that can instruct the computer or any other programmable data processing device to work in a specific manner, so that the instructions stored in the computer readable memory generate an artifact that includes an instruction apparatus. The instruction apparatus implements a specific function in one or more processes in the flowcharts and/or in one or more blocks in the block diagrams.

These computer program instructions may also be loaded onto a computer or another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

Although some preferred embodiments of the present invention have been described, persons skilled in the art can make changes and modifications to these embodiments once they learn the basic inventive concept. Therefore, the following claims are intended to be construed as to cover the preferred embodiments and all changes and modifications falling within the scope of the present invention.

Obviously, a person skilled in the art can make various modifications and variations to the present invention without departing from the spirit and scope of the present invention. The present invention is intended to cover these modifications and variations provided that they fall within the scope of protection defined by the following claims and their equivalent technologies.

What is claimed is:

1. A data synchronization method, wherein multiple data centers comprise at least two data centers, each data center in the at least two data centers comprises at least two nodes, all service nodes in the at least two data centers map to one distributed hash table (DHT) ring, each consecutive value range in the DHT ring corresponds to a service node, a service node in a first data center in the at least two data centers has at least one backup node that is in at least one second data center in the at least two data centers and whose data interval distribution is corresponding to that of the service node, the method comprising:
acquiring, by a management node, a route update message that instructs to update routing information of the first data center and the second data center, wherein the routing information comprises at least identification information of the first data center and the second data center, and backup routing information of nodes in the first data center and the second data center;
adjusting, by the management node, the routing information of the first data center and the second data center according to the route update message; and
synchronizing, by the management node, adjusted routing information of the first data center and the second data center to the first data center and the second data center, so that the first data center and the second data center perform, based on the adjusted routing information, synchronous transmission on data of managed nodes.

2. The method according to claim 1, wherein the backup routing information comprises:
range information corresponding to a node;
attribute information indicating that the node is a service node or a backup node; and
backup node information of the node, wherein when the node is a service node, the backup node information of the node is routing information of a backup node that is used to back up data in the node.

3. The method according to claim 2, wherein adjusting, by the management node, the routing information of the first data center and the second data center according to the route update message comprises:
adjusting, by the management node, the backup routing information in the routing information of the first data center and the second data center according to a parameter in the route update message, wherein the parameter in the route update message comprises one or any combination of:
a parameter of change of a range mapped by a service node that corresponds to a backup node,
a parameter of change of a backup node, and
a parameter of a range service switchover corresponding to a backup node or service node, wherein the parameter of a range service switchover corresponding to the backup node or service node is a parameter that is used to indicate that the backup node or the service node serves as a service node or a backup node.

4. The method according to claim 3, wherein
when the parameter in the route update message is a parameter of change of a range mapped by a first service node that is in the first data center and corresponds to a backup node, adjusting, by the management node, the backup routing information in the routing information of the first data center and the second data center according to a parameter in the route update message comprises:
adjusting, by the management node by using a load balancing policy or a hash algorithm or a range merging algorithm and based on the parameter of change of a range mapped by the first service node, range distribution that is mapped by each service node in the first service node and a related second service node in the first data center and is in the routing information, and correspondingly adjusting range distribution that is of at least one backup node in the second data center and is in the routing information, wherein the at least one backup node is corresponding to the first service node and the second service node.

5. The method according to claim 3, wherein:
when the parameter in the route update message is a parameter of change of a first backup node in the second data center, the adjusting, by the management node, the backup routing information in the routing information of the first data center and the second data center according to a parameter in the route update message comprises:
acquiring, by the management node, a factor corresponding to the parameter of change of the first backup node, wherein the factor is used to trigger change in the first backup node; and
when the management node detects that the factor is that a backup node is disconnected or data is migrated, the method further comprises:
adjusting, by using a range merging algorithm, range distribution that is corresponding to the first backup node and a related second backup node and is in the routing information, and correspondingly adjusting backup node information that is of each service node in at least two service nodes and is in the routing information, wherein the at least two service nodes are service nodes that are corresponding to the first backup node and the second backup node and are in the first data center.

6. The method according to claim 3, wherein when the parameter in the route update message is a parameter of a range service switchover corresponding to a third service node in the first data center, adjusting, by the management node, the backup routing information in the routing information of the first data center and the second data center according to a parameter in the route update message comprises:
determining, by the management node, a third backup node that is corresponding to the third service node and is in the second data center; and
adjusting, by the management node and based on the parameter of a range service switchover corresponding to the third service node, attribute information of the third service node in the routing information from first attribute information to second attribute information, deleting routing information of the third backup node from backup node information of the third service node, adjusting attribute information of the third backup node in the routing information from the second attribute information to the first attribute information, and adding routing information of the third service node to backup node information of the third backup node, wherein the first attribute information is information that is used to indicate that a node is a service node, and the second attribute information is information that is used to indicate that a node is a backup node.

7. The method according to claim 1, wherein routing table information of each data center in the multiple data centers is stored in the management node, and the routing table information comprises identification information uniquely corresponding to each data center and routing information of each data center.

8. A data synchronization apparatus, wherein the data synchronization apparatus is separately communicatively connected to each data center in multiple data centers, the multiple data centers comprise at least two data centers, each data center in the at least two data centers comprises at least two nodes, all service nodes in the at least two data centers map to one distributed hash table DHT ring, each consecutive value range in the DHT ring corresponds to a service node, a service node in a first data center in the at least two data centers has at least one backup node that is in at least one second data center in the at least two data centers and whose data interval distribution is corresponding to that of the service node, the data synchronization apparatus comprising:
a storage device, configured to store routing table information of each data center in the multiple data centers, wherein the routing table information comprises identification information uniquely corresponding to each data center and routing information of each data center;
a controller, configured to:
acquire a route update message that instructs to update routing information of the first data center and the second data center, wherein the routing information comprises at least identification information of the first data center and the second data center, and backup routing information of nodes in the first data center and the second data center, and
adjust the routing information of the first data center and the second data center according to the route update message; and
a transmitter, configured to synchronize adjusted routing information of the first data center and the second data center to the first data center and the second data center, so that the first data center and the second data center perform, based on the adjusted routing information, synchronous transmission on data of managed nodes.

9. The apparatus according to claim 8, wherein the backup routing information comprises:
range information corresponding to a node;
attribute information indicating that the node is a service node or a backup node; and
backup node information of the node, wherein when the node is a service node, the backup node information of the node is routing information of a backup node that is used to back up data in the node.

10. The apparatus according to claim 9, wherein the controller is configured to:
adjust the backup routing information in the routing information of the first data center and the second data center according to a parameter in the route update message, wherein the parameter in the route update message comprises one or any combination of:
a parameter of change of a range mapped by a service node that corresponds to a backup node;
a parameter of change of a backup node; and
a parameter of a range service switchover corresponding to a backup node or service node, wherein the parameter of a range service switchover corresponding to the backup node or service node is a parameter that is used to indicate that the backup node or the service node serves as a service node or a backup node.

11. The apparatus according to claim 10, wherein the controller is further configured to:
when the parameter in the route update message is a parameter of change of a range mapped by a first service node that is in the first data center and is corresponding to a backup node, adjust, by using a load balancing policy or a hash algorithm or a range merging algorithm and based on the parameter of change of a range mapped by the first service node, range distribution that is mapped by each service node in the first service node and a related second service node in the first data center and is in the routing information, and correspondingly adjust range distribution that is of at least one backup node in the second data center and is in the routing information, wherein the at least one backup node is corresponding to the first service node and the second service node.

12. The apparatus according to claim 10, wherein the controller is further configured to:
when the parameter in the route update message is a parameter of change of a first backup node in the second data center, acquire a factor corresponding to the parameter of change of the first backup node, wherein the factor is used to trigger change in the first backup node; and when it is detected that the factor is that a backup node is disconnected or data is migrated, adjust, by using a range merging algorithm, range distribution that is corresponding to the first backup node and a related second backup node and is in the routing information, and correspondingly adjust backup node information that is of each service node in at least two service nodes and is in the routing information, wherein the at least two service nodes are service nodes that are corresponding to the first backup node and the second backup node and are in the first data center.

13. The apparatus according to claim 10, wherein the controller is further configured to:
when the parameter in the route update message is a parameter of a range service switchover corresponding to a third service node in the first data center, determine a third backup node that is corresponding to the third service node and is in the second data center, adjust, based on the parameter of a range service switchover corresponding to the third service node, attribute information of the third service node in the routing information from first attribute information to second attribute information, delete routing information of the third backup node from backup node information of the third service node, adjust attribute information of the third backup node in the routing information from the second attribute information to the first attribute information, and add routing information of the third service node to backup node information of the third backup node, wherein the first attribute information is information that is used to indicate that a node is a service node, and the second attribute information is information that is used to indicate that a node is a backup node.

14. A distributed system, comprising:
multiple data centers, comprising at least two data centers, wherein each data center in the at least two data centers comprises at least two nodes, all service nodes in the at least two data centers map to one distributed hash table (DHT) ring, each consecutive value range in the DHT ring corresponds to a service node, and a service node in a first data center in the at least two data centers has at least one backup node that is in at least one second data center in the at least two data centers and whose data interval distribution is corresponding to that of the service node; and
a management node, communicatively connected to each data center in the multiple data centers, configured to:
acquire a route update message that instructs to update routing information of the first data center and the second data center, wherein the routing information comprises at least identification information of the first data center and the second data center, and backup routing information of nodes in the first data center and the second data center,
adjust the routing information of the first data center and the second data center according to the route update message, and
synchronize adjusted routing information of the first data center and the second data center to the first data center and the second data center, so that the first data center and the second data center perform, based on the adjusted routing information, synchronous transmission on data of managed nodes.

15. The system according to claim 14, wherein the backup routing infoiniation comprises:
range information corresponding to a node;
attribute information indicating that the node is a service node or a backup node; and
backup node information of the node, wherein when the node is a service node, the backup node information of the node is routing information of a backup node that is used to back up data in the node.

16. The system according to claim 15, wherein the management node is configured to:
adjust the backup routing information in the routing information of the first data center and the second data center according to a parameter in the route update message, wherein the parameter in the route update message comprises one or any combination of:
a parameter of change of a range mapped by a service node that corresponds to a backup node,
a parameter of change of a backup node, and
a parameter of a range service switchover corresponding to a backup node or service node, wherein the parameter of a range service switchover corresponding to the backup node or service node is a parameter that is used to indicate that the backup node or the service node serves as a service node or a backup node.

17. The system according to claim 16, wherein the management node is further configured to:
when the parameter in the route update message is a parameter of change of a range mapped by a first service node that is in the first data center and is corresponding to a backup node, adjust, by using a load balancing policy or a hash algorithm or a range merging algorithm and based on the parameter of change of a range mapped by the first service node, range distribution that is mapped by each service node in the first service node and a related second service node in the first data center and is in the routing information, and correspondingly adjust range distribution that is of at least one backup node in the second data center and is in the routing information, wherein the at least one backup node is corresponding to the first service node and the second service node.

18. The system according to claim 16, wherein the management node is further configured to:
when the parameter in the route update message is a parameter of change of a first backup node in the second data center, acquire a factor corresponding to the parameter of change of the first backup node, wherein the factor is used to trigger change in the first backup node; and when it is detected that the factor is that a backup node is disconnected or data is migrated, adjust, by using a range merging algorithm, range distribution that is corresponding to the first backup node and a related second backup node and is in the routing information, and correspondingly adjust backup node information that is of each service node in at least two service nodes and is in the routing information, wherein the at least two service nodes are service nodes that are corresponding to the first backup node and the second backup node and are in the first data center.

19. The system according to claim 16, wherein the management node is further configured to:
when the parameter in the route update message is a parameter of a range service switchover corresponding to a third service node in the first data center, determine a third backup node that is corresponding to the third service node and is in the second data center, adjust, based on the parameter of a range service switchover corresponding to the third service node, attribute information of the third service node in the routing information from first attribute information to second attribute information, delete routing information of the third backup node from backup node information of the third service node, adjust attribute information of the third backup node in the routing information from the second attribute information to the first attribute information, and add routing information of the third service node to backup node information of the third backup node, wherein the first attribute information is information that is used to indicate that a node is a service node, and the second attribute information is information that is used to indicate that a node is a backup node.

20. The system according to claim 14, wherein the management node is further configured to:
store routing table information of each data center in the multiple data centers, wherein the routing table information comprises identification information uniquely corresponding to each data center and routing information of each data center.
